(19) United States
(12) Patent Application Publication
(10) Pub. No.: US 2024/0361592 A1
(43) Pub. Date: Oct. 31, 2024

(54) FULL COLOR EYE-PUPIL-EXPANDERS WITH HIGH VERTICAL FIELD OF VIEW

(71) Applicant: InterDigital CE Patent Holdings, SAS, Paris (FR)

(72) Inventors: Oksana SHRAMKOVA, Liffré (FR); Valter DRAZIC, Betton (FR); Guillaume BOURCIN, Brest (FR)

(21) Appl. No.: 18/701,123

(22) PCT Filed: Oct. 10, 2022
(86) PCT No.: PCT/EP2022/078068

§ 371 Date: Apr. 12, 2024

(51) Int. Cl. G02B 27/00; G02B 27/01

(52) U.S. Cl. CPC G02B 27/0081; G02B 6/0016; G02B 6/0038; G02B 27/0172

(57) ABSTRACT

In example embodiments. a waveguide apparatus is provided that may be used in a display device. The waveguide includes an in-coupler, an out-coupler, and at least a first eye-pupil expander along a first optical path from the in-coupler to the out-coupler. The in-coupler comprises a first diffraction grating and a second diffraction grating overlaying the first diffraction grating. wherein grating lines of the first and second diffraction gratings are parallel to one another. The first eye-pupil expander comprises a third diffraction grating and a fourth diffraction grating overlaying the third diffraction grating. The out-coupler comprises a fifth diffraction grating and a sixth diffraction grating overlaying the fifth diffraction grating.

### CROSS-REFERENCE TO RELATED APPLICATION

This application claims priority of European Patent Application No. EP21306431.4, filed 12 Oct. 2021, which is incorporated herein by reference in its entirety.

### BACKGROUND

The present disclosure is related to the field of optics and photonics and more specifically to the domain of augmented reality (AR) near-eye displays (NED). An AR NED is a form of advanced display technology that can potentially reshape existing ways of performing tasks by allowing its user to visualize virtual images/information superimposed onto the real-world environment simultaneously thereby enhancing the user's view of the real world. Its applications are numerous including in navigation, military, medicine, entertainment and education to name a few.

This section is intended to introduce the reader to various aspects of art, which may be related to various aspects of the present disclosure that are described and/or claimed below. This discussion is believed to be helpful in providing the reader with background information to facilitate a better understanding of the various aspects of the systems and methods described herein. Accordingly, it should be understood that these statements are to be read in this light and not as admissions of prior art.

Development of AR/VR glasses (and more generally eyewear electronic devices) is associated with a number of challenges, including reduction of size and weight of such devices as well as improvement of the image quality (in terms of contrast, field of view, color depth, etc.) that should be realistic enough to enable a truly immersive user experience.

In such AR/VR glasses, various types of refractive and diffractive lenses and beam-forming components are used to guide the light from a micro-display or a projector towards the human eye, allowing forming a virtual image that is superimposed with an image of the physical world seen with a naked eye (in case of AR glasses) or captured by a camera (in case of VR glasses).

Some of kinds of AR/VR glasses utilize optical waveguides wherein light propagates into the optical waveguide by TIR (for Total Internal Reflection) only over a limited range of internal angles. The FoV (for Field of View) of the waveguide depends on the material of the waveguide. The FoV of a waveguide may be expressed as the maximum span of θ₁⁺-θ₁⁻ which propagates into the waveguide by TIR. In some systems, the FoV is a function of the index of refraction of the material of the waveguide. For example, the FoV of a waveguide of refractive index n₂ may be given by:

$$Δ {θ}_{1} = 2 {sin}^{- 1} ( \frac{{n}_{2} - 1}{2} ) .$$

For n₂=1.5 the total field of view for a single mode system is rather limited to Δθ₁=28.96 degrees. It can be seen that 60 degrees FoV is a practical limit for some types of waveguides because it is not generally feasible to use materials of refractive index above 2.0.

AR displays preferably fulfill certain criteria such as a high field of view, a large exit pupil and good uniformity along with light weight, and thin and compact size. Common NED technology solutions include freeform prisms, deformable mirrors, and holographic projection. For an eyeglass-like form factor that enables easy mobility and everyday use, an optical waveguide based design, such as those using diffractive waveguides with surface relief gratings as the diffractive elements, is one potential solution. Surface relief gratings are diffractive optical elements that serve to in-couple the incident light from the display source into the optical waveguide. Then, light is totally internally reflected inside the waveguide before being outcoupled towards the user's eyes with another grating.

One approach for the realization of a near-eye augmented reality (AR) display system is based on optical waveguide technology. The basic optical components integrated into the waveguide combiners consist of in-and out-couplers, and the Eye Pupil Expander (EPE) which are fabricated as diffractive optical elements or holographic volume gratings. To develop a waveguide display system with a wide Field of View (FoV) and a good spatial and angular uniformity, a high refractive index surface relief diffractive grating can be used which angularly tiles the exit pupil of the light-engine. As a result, using positive and negative diffraction modes of the in-coupling can guide the light towards both left and right directions inside the waveguide. Such a system doubles the horizontal FoV as each half-image can use the whole angular bandwidth of the waveguide in each direction of propagation. The combination of these halves will be done by the pupil expanders and out-couplers at the exit of the waveguide.

Recently, two waveguides full RGB combiner architectures have been investigated, reducing by 30% the weight and size of traditional three-waveguide combiners, where the green FoV was shared between first and second waveguides. But this solution does not demonstrate high FoV.

For AR applications, several full-color waveguide solutions have been developed for light in-coupling into the optical device. To enable the transmission of multiple wavelengths with high RGB FoV, it is possible to fabricate a multi-waveguide solution representing a combination of the stacked waveguides configured for a different color. Double and single waveguide full RGB combiner architectures have been proposed. In the case of a double waveguide solution, different architectures were proposed. One architecture is based on the splitting of the green FoV between first and second waveguides. For another configuration it was proposed to use the first waveguide for the blue and green FoV's in-coupling, while the second one to in-couple the red color's FoV. Both architectures reduce the overall FOV of the system allowed by the parameters of the waveguide material. Current solutions for full RGB waveguide couplers are primarily based on accurate alignment of three holographic diffraction gratings and have quite a small overall FoV.

### SUMMARY

References in the specification to “one embodiment,” “an embodiment,” “an example embodiment,” and the like indicate that the embodiment described may include a particular feature, structure, or characteristic; but not every embodiment necessarily includes that particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described.

A waveguide apparatus according to some embodiments includes a waveguide having an in-coupler, an out-coupler, and at least a first eye-pupil expander along a first optical path from the in-coupler to the out-coupler, wherein: the in-coupler comprises a first diffraction grating and a second diffraction grating overlaying the first diffraction grating; the first eye-pupil expander comprises a third diffraction grating and a fourth diffraction grating overlaying the third diffraction grating; and the out-coupler comprises a fifth diffraction grating and a sixth diffraction grating overlaying the fifth diffraction grating.

In some embodiments, the eye-pupil expander further comprises a seventh diffraction grating and an eighth diffraction grating, the seventh and eighth diffraction gratings overlaying the third and fourth diffraction gratings.

In some embodiments, the out-coupler further comprises a ninth diffraction grating and a tenth diffraction grating, the ninth and tenth diffraction gratings overlaying the fifth and sixth diffraction gratings.

In some embodiments, at least one of the following pairs of diffraction gratings are on opposite surfaces of the waveguide: the first and second diffraction gratings, the third and fourth diffraction gratings, and the fifth and sixth diffraction gratings.

In some embodiments, at least one of the following pairs of diffraction gratings forms a metagrating within the waveguide: the first and second diffraction gratings, the third and fourth diffraction gratings, and the fifth and sixth diffraction gratings.

In some embodiments, grating lines of the third and fourth diffraction gratings are not parallel to one another. Parameters of at least the third and fourth diffraction grating may be selected at least in part to substantially maximize a vertical field of view.

In some embodiments, grating lines of the first and second diffraction gratings are parallel to one another and grating lines of the fifth and sixth diffraction gratings are parallel to one another.

In some embodiments, the first and third diffraction gratings are configured to diffract light having a first polarization state and the second and fourth diffraction gratings are configured to diffract light having a second polarization state orthogonal to the first polarization state.

Some embodiments further comprise a second eye-pupil expander along a second optical path from the in-coupler to the out-coupler, the second eye-pupil expander being arranged symmetrically with respect to the first eye-pupil expander.

A full-color waveguide display device according to some embodiments comprises a waveguide apparatus as described herein. The display device may include an image generator and the in-coupler may be configured to couple an image generated by the image generator.

A method of operating an apparatus as described herein includes: generating an image; in-coupling the image with the in-coupler; and out-coupling the image with the out-coupler.

### BRIEF DESCRIPTION OF THE DRAWINGS

FIG. 1A is a cross-sectional schematic view of a waveguide display.

FIG. 1B is a schematic illustration of a binocular waveguide display with a first layout of diffractive optical components.

FIG. 1C is a schematic illustration of a binocular waveguide display with a second layout of diffractive optical components.

FIG. 1D is a schematic exploded view of a double-waveguide display.

FIG. 1E is a cross-sectional schematic view of a double-waveguide display.

FIG. 1F is a schematic cross-sectional side view of an in-coupler region of a full color single waveguide in-coupler with two in-coupling diffraction gratings.

FIG. 2A is a schematic cross-sectional side view of an in-coupler region of a full RGB system with a metagrating inside the waveguide.

FIG. 2B is a cross-sectional view of a unit cell of a metagrating as used in some embodiments.

FIG. 2C is a schematic cross-sectional view illustrating the geometry and performance of a metagrating according to some embodiments. In this example of a metagrating, the 4^{th} reflected order R_{±4} (M₁*=4) and 3^{rd} transmitted order T_{±3} (M₂*=3) will be in-coupled into the waveguide.

FIG. 3A is a schematic front view illustrating an example layout of diffraction gratings for a full color waveguide having metagrating in-coupler (MG1), EPE system (MG2, MG2′) and out-coupling grating system (MG3).

FIG. 3B is a schematic front view of a waveguide using the layout of FIG. 3A.

FIG. 3C is a schematic front view of the waveguide of FIG. 3B, illustrating light diffracted along an optical path including diffraction gratings DG1, DG3, and DG7 and along an optical path including diffraction gratings DG1, DG5, and DG7.

FIG. 3D is a schematic front view of the waveguide of FIG. 3B, illustrating light diffracted along an optical path including diffraction gratings DG2, DG4, and DG8 and along an optical path including diffraction gratings DG2, DG6, and DG8.

FIG. 3E graphically illustrates grating vectors and corresponding angles used in an example embodiment.

FIG. 4 illustrates angles used in defining conical mounting parameters.

FIG. 5A is a schematic cross-sectional side view of a portion of a waveguide showing an external combination of EPE gratings according to some embodiments.

FIG. 5B is a schematic cross-sectional side view of a portion of a waveguide showing an internal EPE metagrating according to some embodiments.

FIG. 6A is a schematic cross-sectional side view of a portion of a waveguide showing an arrangement of four EPE gratings according to some embodiments.

FIG. 6B is a schematic cross-sectional side view of a portion of a waveguide showing an arrangement of four out-coupling gratings according to some embodiments.

FIG. 6C graphically illustrates grating vectors and corresponding angles used in an example embodiment.

FIG. 7 is a schematic front view of an example diffraction grating layout for a full color waveguide having metagrating in-coupler (MG1), EPE system (MG2 and MG2′) and out-coupling grating system (MG3 and MG3′).

FIG. 8 is a schematic cross-sectional views of a unit cell of high refractive index material reflective diffraction grating.

FIG. 9A illustrates diffraction performance of DG3 at a blue color wavelength using a unit cell configuration as shown in FIG. 10A.

FIG. 9B illustrates diffraction performance of XDG3 at a blue color wavelength using a unit cell configuration as shown in FIG. 10B.

FIG. 10A illustrates an example unit cell configuration for DG3.

FIG. 10B illustrates an example unit cell configuration for XDG3.

FIG. 11A illustrates diffraction performance of DG3 at a green color wavelength using a unit cell configuration as shown in FIG. 10A.

FIG. 11B illustrates diffraction performance of XDG3 at a green color wavelength using a unit cell configuration as shown in FIG. 10B.

FIG. 12A illustrates diffraction performance of DG4 at a red color wavelength using a unit cell configuration as shown in FIG. 13A.

FIG. 12B illustrates diffraction performance of XDG4 at a red color wavelength using a unit cell configuration as shown in FIG. 13B.

FIG. 13A illustrates an example unit cell configuration for DG4.

FIG. 13B illustrates an example unit cell configuration for XDG4.

FIG. 14A illustrates diffraction performance of DG4 at a green color wavelength using a unit cell configuration as shown in FIG. 13A.

FIG. 14B illustrates diffraction performance of XDG4 at a green color wavelength using a unit cell configuration as shown in FIG. 13B.

### DETAILED DESCRIPTION

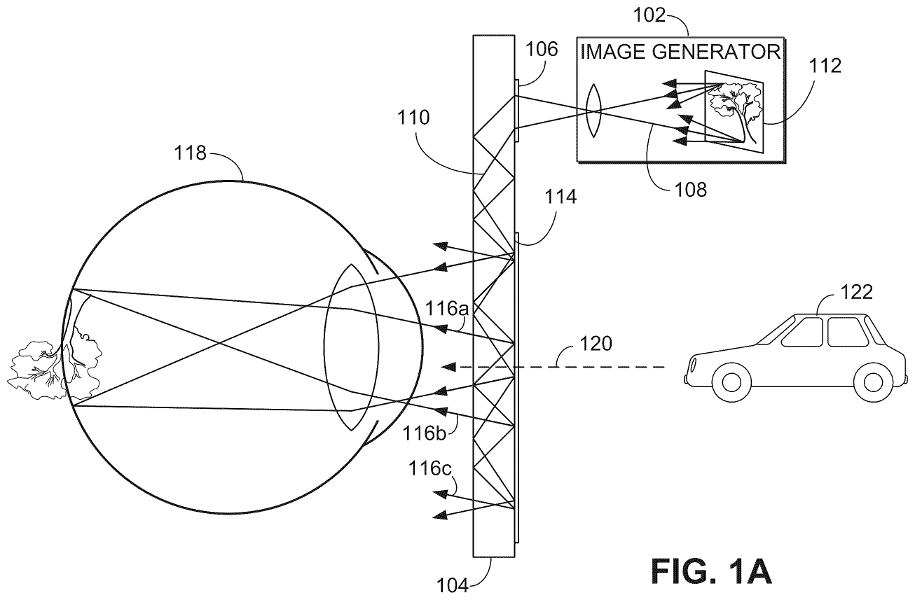

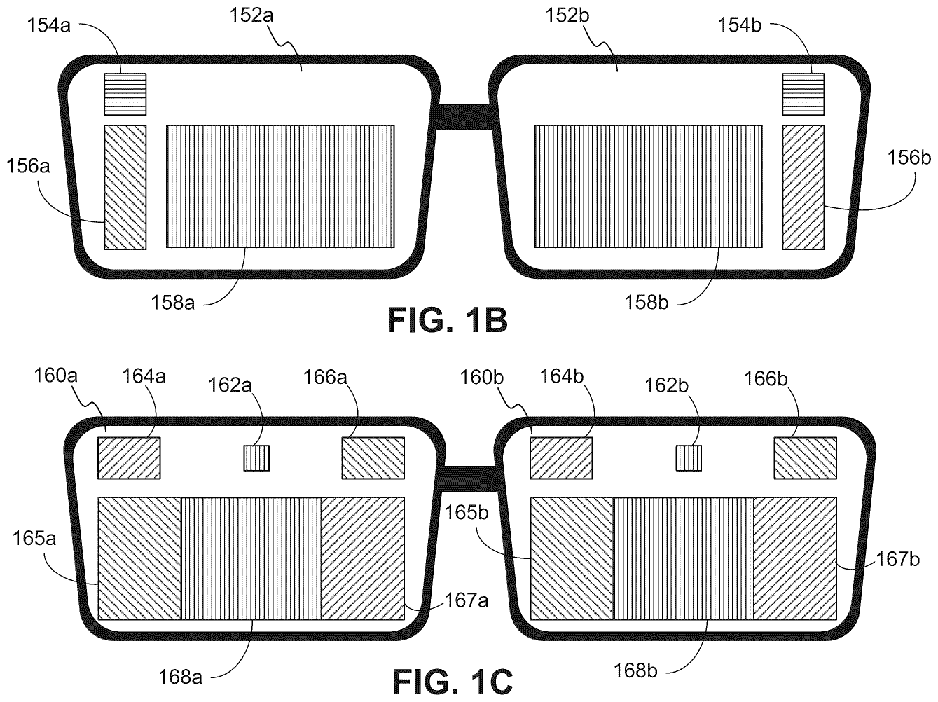

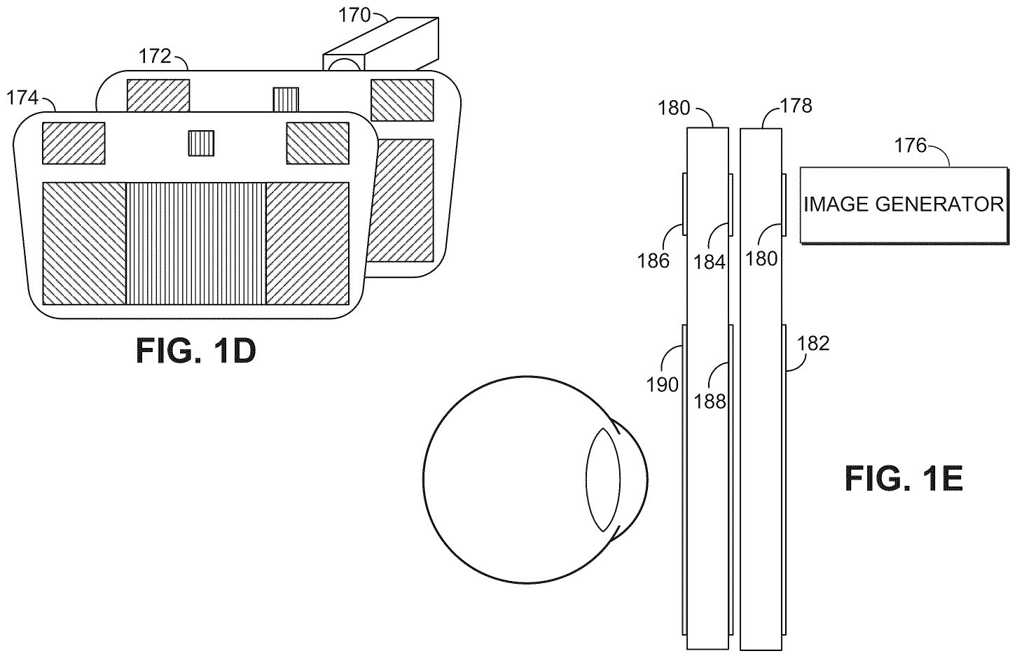

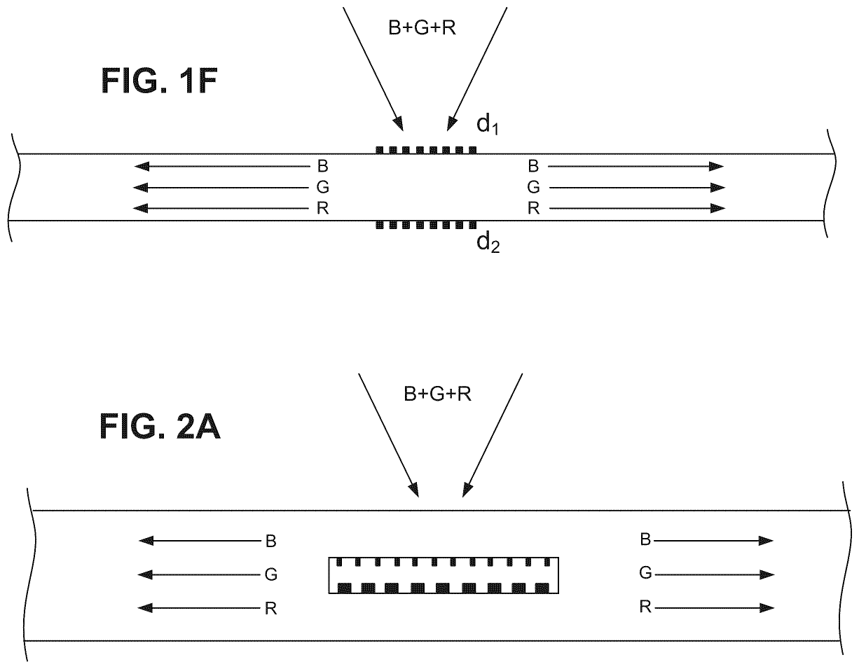

Described herein are waveguide display systems and methods. An example waveguide display device is illustrated in FIG. 1A. FIG. 1A is a schematic cross-sectional side view of a waveguide display device in operation. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

Some waveguide displays includes more than one waveguide layer. Each waveguide layer may be configured to preferentially convey light with a particular range of wavelengths and/or incident angles from the image generator to the viewer.

As illustrated in FIGS. 1B and 1C, waveguide displays having in-couplers, out-couplers, and pupil expanders may have various different configurations. An example layout of one binocular waveguide display is illustrated in FIG. 1B. In the example of FIG. 1B, the display includes waveguides 152a, 152b for the left and right eyes, respectively. The waveguides include in-couplers 154a,b, pupil expanders 156a,b, and components 158a,b, which operate as both out-couplers and horizontal pupil expanders. The pupil expanders 156a,b are arranged along an optical path between the in-coupler and the out-coupler. An image generator (not shown) may be provided for each eye and arranged to project light representing an image on the respective in-coupler.

An layout of another binocular waveguide display is illustrated in FIG. 1C. In the display of FIG. 1C, the display includes waveguides 160a, 160b for the left and right eyes, respectively. The waveguides include in-couplers 162a,b. Light from different portions of an image may be coupled by the in-couplers 162a,b to different directions within the waveguides. In-coupled light traveling toward the left passes through pupil expanders 164a,b and 165a,b, while in-coupled light traveling toward the right passes through pupil expanders 166a,b and 167a,b. Having passed through the pupil expanders, light is coupled out of the waveguides using out-couplers 168a,b to substantially replicate an image provided at the in-couplers 162a,b.

In different embodiments, different features of the waveguide displays may be provided on different surfaces of the waveguides. For example (as in the configuration of FIG. 1A), the in-coupler and the out-coupler may both be arranged on the anterior surface of the waveguide (away from the user's eye). In other embodiments, the in-coupler and/or the out-coupler may be on a posterior surface of the waveguide (toward the user's eye). The in-coupler and out-coupler may be on opposite surfaces of the waveguide. In some embodiments, one or more of an in-coupler, an out-coupler, and a pupil expander, may be present on both surfaces of the waveguide. The image generator may be arranged toward the anterior surface or toward the posterior surface of the waveguide. The in-coupler is not necessarily on the same side of the waveguide as the image generator. Any pupil expanders in a waveguide may be arranged on the anterior surface, on the posterior surface, or on both surfaces of the waveguide. In displays with more than one waveguide layer, different layers may have different configurations of in-coupler, out-coupler, and pupil expander.

FIG. 1D is a schematic exploded view of a double waveguide display, including an image generator 170, a first waveguide 172, and a second waveguide 174. FIG. 1E is a schematic side-view of a double waveguide display, including an image generator 176, a first waveguide 178, and a second waveguide 180. The first waveguide includes a first transmissive diffractive in-coupler 180 and a first diffractive out-coupler 182. The second waveguide has a second transmissive diffractive in-coupler 184, a reflective diffractive in-coupler 186, a second diffractive out-coupler 188, and a third diffractive out-coupler 190. Different displays may use different arrangements of optical components (such as different arrangements of pupil expanders) on the first and second waveguides.

New types of full-color single-waveguide EPE systems are described herein. In contrast to the existing EPE solutions, the proposed full-color EPE solutions represents the combination of two reflective differently-oriented diffraction gratings which could be placed from both sides of the waveguide for a full color system or can be fabricated as a metagrating inside the waveguide. In embodiments where the grating is embedded into the waveguide, the system of metagratings (including in-and out-coupling metagratings) will be protected from mechanical damage and degradation. To increase the vertical field of view (FoV) of the full system, example embodiments use two additional reflective EPE gratings which can be combined with the embedded metagrating solution. Several possible combinations of EPE systems with out-coupling gratings are described. Compared to previous art, some examples of waveguide systems as described herein can exhibit a high FoV for all three colors.

The present disclosure relates to the field of optics and photonics, and more specifically to optical device comprising at least one diffraction grating. It may find applications in the field of conformable and wearable optics (i.e. AR/VR glasses (Augmented Reality/Virtual Reality)), as well as in a variety of other electronic consumer products comprising displays and/or lightweight imaging systems.

The present applicant has previously proposed single-waveguide full-color solutions with high in-coupled efficiency across a wide angular range. In such architectures, a single waveguide combiner configuration is based on the diffraction of an incident light by two diffraction gratings and in-coupling it into the waveguide. In one design, one transmissive and one reflective surface relief grating are placed on both sides of the waveguide. Another design uses a metagrating solution inside a waveguide that operates to combine the beams diffracted by the reflective grating on the top of metagrating system and transmissive diffraction gratings at the bottom of the system. The combination of diffraction gratings provides a very high FoV for three in-coupled RGB colors.

FIG. 1F is a schematic side view of the full color single waveguide in-coupler with two in-coupling diffraction gratings.

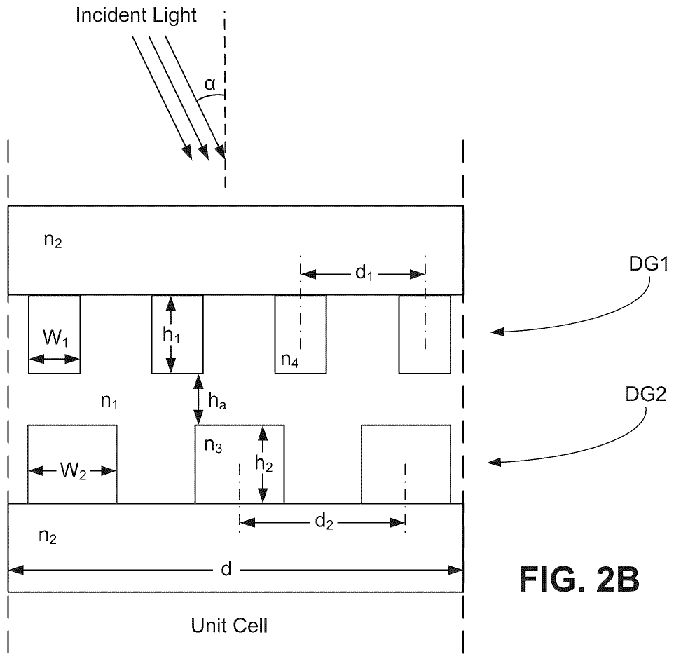

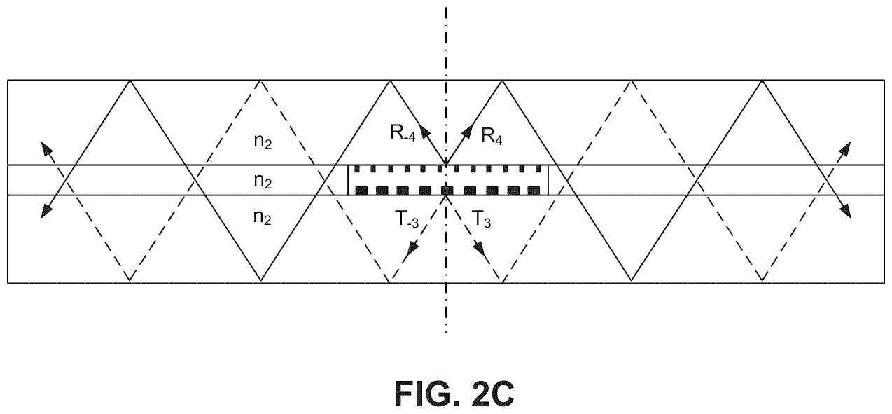

FIG. 2A is a schematic side view of a full RGB waveguide system with a metagrating in-coupler inside the waveguide.

FIG. 2B is a cross-sectional view of a unit cell of an example metagrating.

FIG. 2C illustrates the geometry and performance of an example proposed metagrating. In this example, the 4^{th} reflected order R_{±4} (M₁*=4) and 3^{rd} transmitted order T_{±3} (M₂*=3) will be in-coupled into the waveguide.

Constitutive parts of metagrating are different diffraction gratings in that they have a different period calculated for the proper wavelength and may have different size and material of the elements, but the geometrical structure that emphasize the edge-waves can be of the same shape. Using the elements of a different shape we have an additional degree of freedom providing the possibility to improve the performance of the system.

The general topology of the unit cell of an example proposed metagrating is illustrated in FIG. 2B. This cross-sectional view may correspond to the high refractive index (n₄) elements from the bottom of a homogeneous dielectric plate with a refractive index n₂ (n₄>n₂), d₁ is the period of this first grating, w₁ and h₁ are width and height of the high refractive index elements. The second part of proposed metagrating contains the high refractive index (n₃) elements on the top of a homogeneous dielectric plate with a refractive index n₂ (n₃>n₂), d₂ is the period of the second grating, w₂ and h₂ are width and height of the high refractive index element.

To get the unit cell of diffraction metagrating we combine two plates with first (DG1) and second (DG2) diffraction gratings. The distance between the plates/substrates may be equal to h₁+h₂+hₐ, where hₐ is the distance between the elements (see FIG. 2B). This distance between the elements of two gratings and substrates is filled by the material with low refractive index n₁ (n₁<n₂). In general, this media can be air, but it may be a vacuum or a different substance.

We can present the equations for the period of first reflective diffraction grating DG1 in a such form:

$${d}_{1} = \frac{{M}_{1} {λ}_{B}}{{n}_{2 B} sin {Φ}_{1}^{G} - {n}_{1} sin {Θ}_{1}^{G}} \qquad Eq . ( 1 A )$$

The pitch size d₂ of the second transmissive diffraction grating can be presented in the following form.

$${d}_{2} = \frac{{M}_{2} {λ}_{R}}{{n}_{2 R} sin {Φ}_{2}^{G} + {n}_{1} sin {Θ}_{2}^{G}} . \qquad Eq . ( 1 B )$$

Here, M₁ and M₂ correspond respectively to the diffraction orders of the first and second diffraction gratings, the rays incident on the in-coupler with angles ±θ₁^{G} (overlapping angle) in the vicinity of the normal get diffracted with grazing angles ±Φ₁^{G}, Φ₁^{G} and Φ₂^{G} are chosen to approximately equal to 75°, n_{2B,2R} correspond to refractive index of the waveguide material at blue and red color wavelengths (λ_{B,R}).

Assuming that the period of the metagrating is equal to d=4d₁=3d₂, we can obtain the relationship between the angles Θ₁^{G} and Θ₂^{G}.

$$sin {Θ}_{2}^{G} = \frac{1}{{n}_{1}} ( \frac{3 {M}_{2} {λ}_{R}}{4 {M}_{1} {λ}_{B}} ( {n}_{2 B} sin {Φ}_{1}^{G} - {n}_{1} sin {Θ}_{1}^{G} ) - {n}_{2 R} sin {Φ}_{2}^{G} ) \qquad Eq . ( 2 )$$

Selecting the reflective and transmissive parts of metagrating to in-couple first diffraction orders (M₁=M₂=1) we get the metagrating for which 4th reflected order R_{±4} (M₁*=4) and 3rd transmitted order T_{±3} (M₂*=3) will be in-coupled into the waveguide. This means we consider here a dual diffraction grating system where the pupil is split angularly, but the embedded metagrating could also be used to couple the whole field of view into just one direction, toward the left or toward the right-hand side. In that case, the basic geometries of the elements in the grating may be selected to be nonsymmetric. The distribution of the diffracted light inside the waveguide is presented in FIG. 2C.

The main role of the exit pupil expander (EPE) is to deviate a wide optical beam and duplicate a single pupil into many. The design of the EPE (the component that is typically in TIR conical mounting) calls for a selection of the grating's pitch in order to achieve a desired vertical FoV. The EPE sets a limitation on the vertical FoV, as described for example in WO 2021144452. It may be desirable for the image to have a specific aspect ratio defined by the aspect ratio of the display, in which case the horizontal FoV may be diminished in practice by the display's size even if it is not limited by the optics.

As it was mentioned before, the vertical field of view of an AR headset based on diffractive optics is limited by the gratings used in TIR conical mountings. Analyzing existing solutions, we can see that for calculated pitch of in-coupling diffraction grating, the displays are symmetrical regarding the horizontal axis providing symmetrical distribution for positive and negative azimuth angles.

Example embodiments provide a new EPE metasurface design for full RGB solution with high vertical FOV. We also aim at proposing solution with high diffraction uniformity for deviated light.

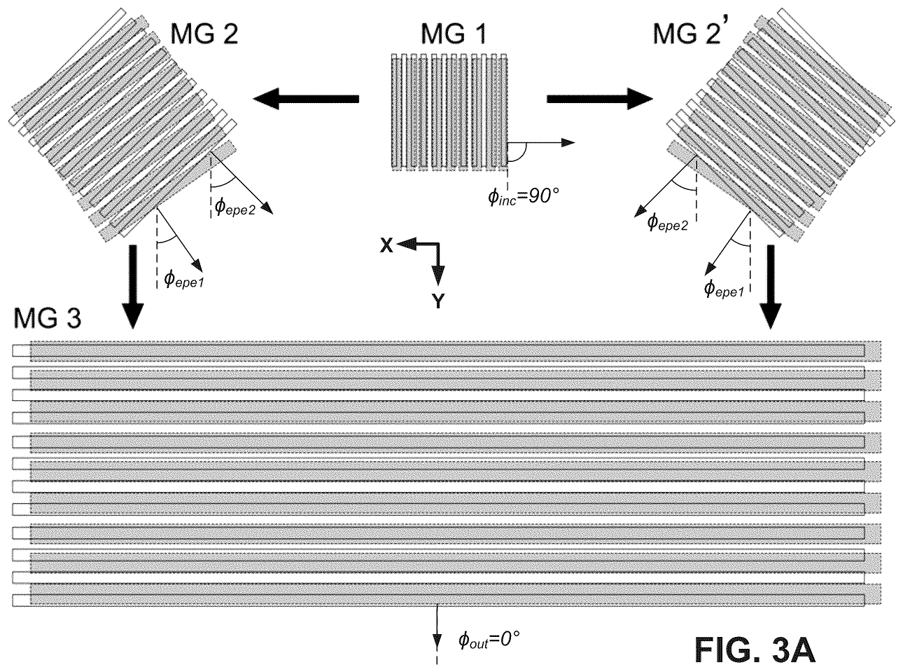

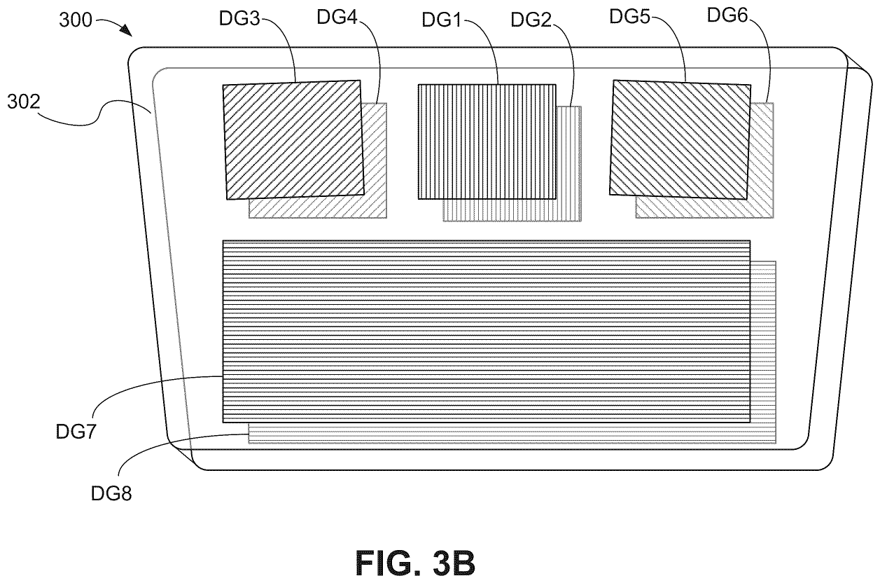

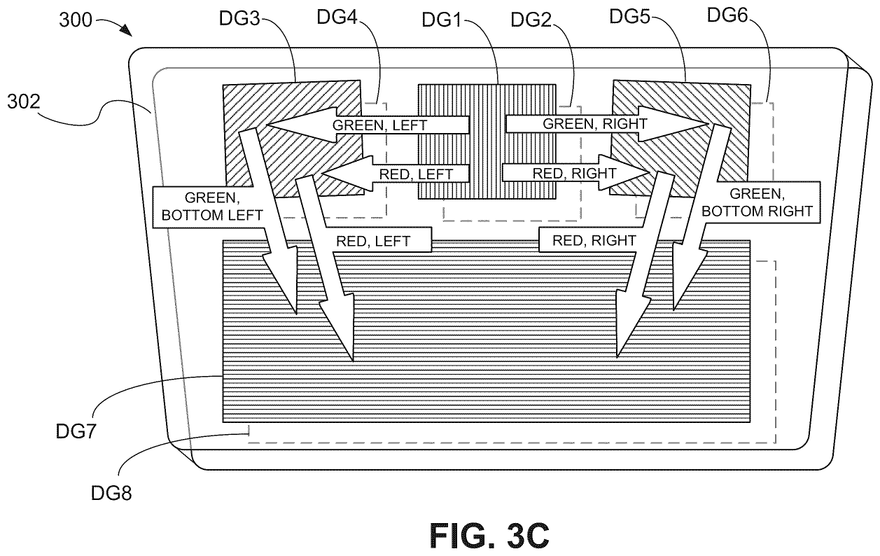

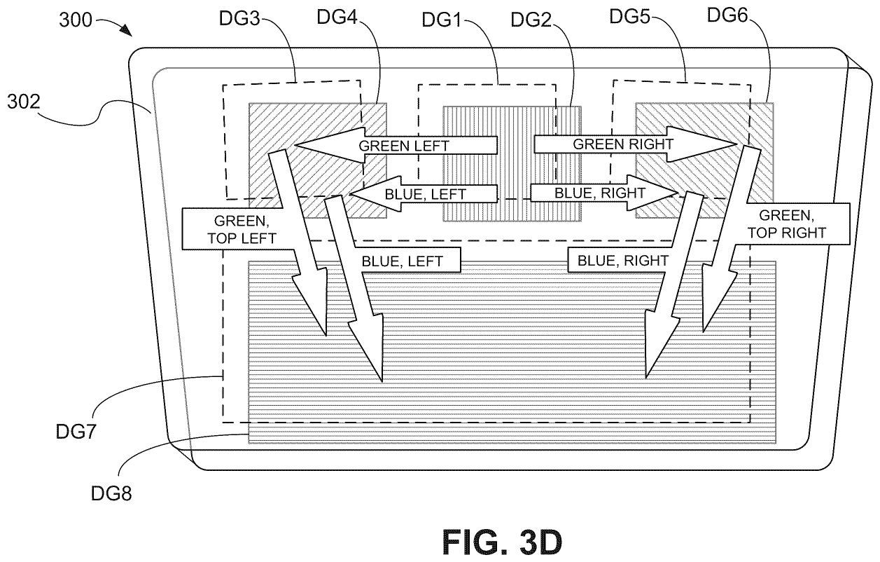

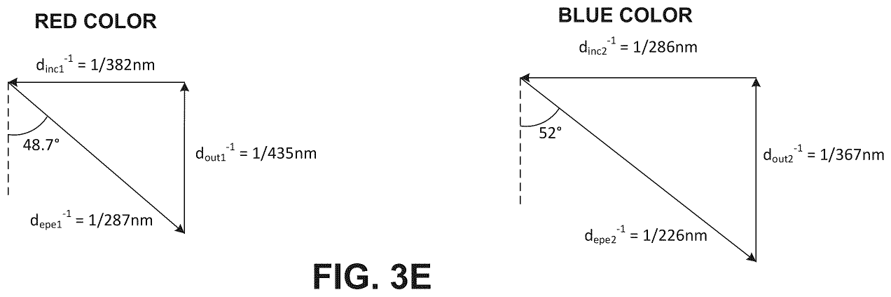

FIG. 3A illustrates a schematic front view of a grating layout for a full color waveguide having metagrating in-coupler (MG1), EPE system (MG2, MG2′) and out-coupling grating system (MG3).

In FIG. 3A we schematically present the full system architecture based on metagrating elements embedded into the waveguide. In some embodiments, each metagrating element represent the combination of two diffraction gratings oriented at some specific angle. In some embodiments, both in-coupling gratings have the same orientation (ϕ_{inc}=90°). They diffract a positive order toward the left-hand side of the figure and a negative order toward the right-hand side. Then we have two similar EPE metagratings oriented symmetrically regarding the y-axis. Each EPE metagrating includes two diffraction gratings which can have different orientations. The EPE metagratings diffract zero orders to expand the pupil horizontally, and non-zero order to deviate the image along the y-axis. For this architecture, the out-coupling grating also expands the pupil in the vertical direction. In FIG. 3A we present a case when both out-coupling gratings have the same orientation (ϕₒᵤₜ=0°).

FIG. 3B illustrates an example of a waveguide 300 using a layout of diffraction gratings as shown in FIG. 3A. In one example, diffraction gratings DG1, DG3, DG5, and DG7 are on a front surface 302 of the waveguide and diffraction gratings DG2, DG4, DG6, and DG8 are on a rear surface opposite the front surface. In another example, one or more of the foregoing gratings are embedded between the surfaces of the waveguide.

FIG. 3C schematically illustrates the coupling of different portions of a field of view through the waveguide 300. Red light in the left half of the field of view is in-coupled by DG1 toward pupil expander DG3, diffracted by DG3 toward DG7, and out-coupled by DG7. Red light in the right half of the field of view is in-coupled by DG1 toward pupil expander DG5, diffracted by DG5 toward DG7, and out-coupled by DG7. (The right and left halves may overlap in part.)

Green light in the left half of the field of view is in-coupled by DG1 toward pupil expander DG3. From DG3, green light in the bottom left portion of the field of view is diffracted along an optical path toward DG7 to be out-coupled for viewing by a user. Some green light in the top portion of the field of view may be diffracted by DG3 toward DG7, but it is likely to be diffracted to an angle greater than the grazing angle and thus not to be effectively propagated through the waveguide toward DG7. (The top and bottom portions may overlap in part.)

Green light in the right half of the field of view is in-coupled by DG1 toward pupil expander DG5. From DG5, green light in the bottom right portion of the field of view is diffracted along an optical path toward DG7 to be out-coupled for viewing by a user. Some green light in the top portion of the field of view may be diffracted by DG5 toward DG7, but it is likely to be diffracted to an angle greater than the grazing angle and thus not to be effectively propagated through the waveguide toward DG7.

FIG. 3D further schematically illustrates the coupling of different portions of a field of view through the waveguide 300. Blue light in the left half of the field of view is in-coupled by DG2 toward pupil expander DG4, diffracted by DG4 toward DG8, and out-coupled by DG8. Blue light in the right half of the field of view is in-coupled by DG2 toward pupil expander DG6, diffracted by DG6 toward DG8, and out-coupled by DG8. (The right and left halves may overlap in part.)

Green light in the left half of the field of view is in-coupled by DG2 toward pupil expander DG4. From DG4, green light in the top portion of the field of view is diffracted along an optical path toward DG8 to be out-coupled for viewing by a user. Some green light in the top portion of the field of view may be diffracted by DG4 toward DG8, but it is likely to be diffracted to an angle less than the critical angle for total internal reflection and thus not to be effectively propagated through the waveguide toward DG8. (The top and bottom portions may overlap in part.)

Green light in the right half of the field of view is in-coupled by DG2 toward pupil expander DG6. From DG6, green light in the top portion of the field of view is diffracted along an optical path toward DG8 to be out-coupled for viewing by a user. Some green light in the top portion of the field of view may be diffracted by DG6 toward DG8, but it is likely to be diffracted to an angle less than the critical angle for total internal reflection and thus not to be effectively propagated through the waveguide toward DG8.

As shown in the example of FIGS. 3A-3E, a waveguide display with a relatively large vertical field of view may be obtained with a waveguide that includes an in-coupler with two diffraction gratings having grating lines that are parallel to one another. This allows for dual-mode in-coupling in which a left portion of a field of view is coupled toward the left side of the waveguide and a right portion of the field of view is coupled toward the right side of the waveguide (possibly with some overlap between the portions). Each side includes an eye-pupil expander system that includes at least two diffraction gratings. One of the diffraction gratings on each side is configured for red light and for a first portion (e.g. the bottom portion) of the field of view for green light, and the other diffraction grating on the same side is configured for blue light and for a second portion (e.g. the upper portion) of the field of view of green light. The diffraction gratings of the eye-pupil expander direct light toward out-coupler gratings of the waveguide. A first out-coupler grating may be configured to out-couple light from one pair of eye-pupil expander gratings (e.g. from the pair configured for red light and the first portion of green light), and a second out-coupler grating may be configured to out-couple light from the other pair of eye-pupil expander gratings (e.g. from the pair configured for blue light and the second portion of green light). In alternative embodiments, as described in greater detail below, additional eye-pupil expander gratings and/or additional out-coupler gratings may be provided to further partition the field of view along different optical paths.

In an example embodiment, an apparatus includes an image generator (102, 170) configured to generate an image with red, green, and blue light. A waveguide is provided with a first in-coupler grating (DG1) and a second in-coupler grating (DG2) configured to in-couple the image. The waveguide further includes at least one out-coupler configured to out-couple the image. The waveguide has a first optical path defined by the first in-coupler grating (DG1) and a first pupil expander grating (DG3). The first optical path is configured to convey red light from a left portion of the image and green light from a bottom-left portion of the image to the out-coupler. The waveguide has a second optical path defined by the first in-coupler grating (DG1) and a second pupil expander grating (DG5). The second optical path is configured to convey red light from a right portion of the image and green light from a bottom-right portion of the image to the out-coupler. The waveguide has a third optical path defined by a second in-coupler grating (DG2) and a third pupil expander grating (DG4). The third optical path is configured to convey blue light from a left portion of the image and green light from a top-left portion of the image to the out-coupler. The waveguide has a fourth optical path defined by the second in-coupler grating (DG2) and a fourth pupil expander grating (DG6). The fourth optical path is configured to convey blue light from a right portion of the image and green light from a top-right portion of the image to the out-coupler.

In some such embodiments, the first optical path is configured to convey light diffracted by the first in-coupler grating (DG1) to a positive diffractive order; the second optical path is configured to convey light diffracted by the first in-coupler grating (DG2) to a negative diffractive order; the third optical path is configured to convey light diffracted by the second in-coupler grating (DG2) to a positive diffractive order; and the fourth optical path is configured to convey light diffracted by the second in-coupler grating (DG2) to a negative diffractive order.

It should be noted that terms such as top, bottom, upper, lower, left, and right are used here with respect to the orientation as shown in the figures, which are provided only as examples. Some embodiments may use rotated, mirrored, or reversed configurations, in which, for example, the top becomes the right, the bottom becomes the left, and so on, without departing from the invention described herein. In some embodiments, with reference to the field of view, the left and right directions are differentiated by a positive versus negative diffractive order of an in-coupler grating, while the up and down directions are perpendicular to the left/right directions in the plane of the waveguide.

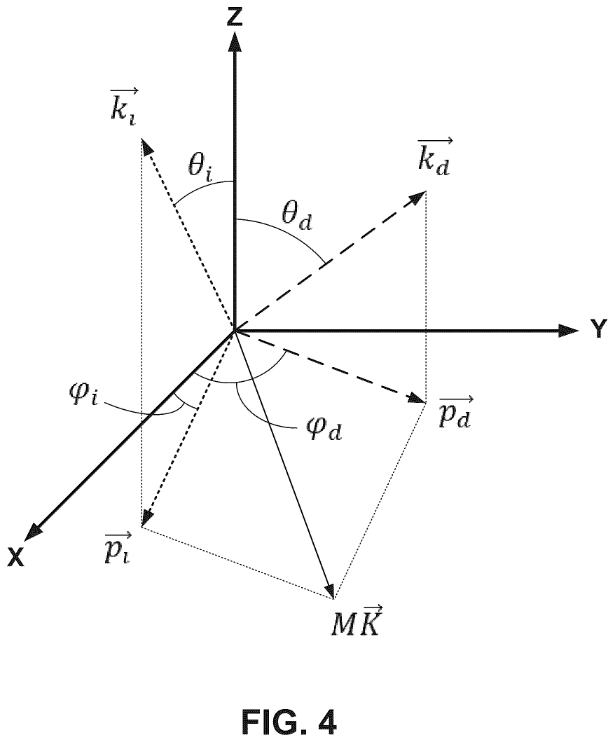

FIG. 4 illustrates an example of angles mentioned in the present specification. A diffraction grating has the lines which are perpendicular to the vector K direction, θᵢ is an incident polar angle; θ_{d} is diffracted polar angle for order M>0; φᵢ and φ_{d} are incident and diffracted azimuth angles; n₁ is the refractive index of the medium outside the waveguide, n₂ is the refractive index of the waveguide material.

For the in-coupler analysis, the diffraction grating orientation angle is ϕ_{inc}=90°. To determine the horizontal FoV, we use φᵢ=0 and φ_{d}=π.

Let us start from the general case consideration. For the in-coupling system, the system of grating equations will be written as follows.

$${n}_{2} sin {θ}_{d} cos {φ}_{d} + {n}_{1} sin {θ}_{i} cos {φ}_{i} = \frac{M λ}{{d}_{inc}} sin {ϕ}_{inc} \qquad Eq . ( 3 A , 3 B )$$

$${n}_{2} sin {θ}_{d} sin {φ}_{d} + {n}_{1} sin {θ}_{i} sin {φ}_{i} = \frac{M λ}{{d}_{inc}} cos {ϕ}_{inc}$$

Here d_{inc} is the period of in-coupling diffraction grating. We note that it is desirable for the diffracted polar angles to be kept above the TIR limit angle and below the grazing limit.

Let us determine the values for vertical FoV. From Eq. (3A) we get Eq. (4):

$${φ}_{d}^{V} = \pm {cos}^{- 1} ( \frac{\frac{M λ}{{d}_{inc}} sin {ϕ}_{inc} - {n}_{1} sin {θ}_{i}^{G} cos {φ}_{i}^{V}}{{n}_{2} sin {θ}_{d}^{G}} )$$

Here θ_{d}^{G} is the maximum grazing incidence inside the waveguide and θ_{d}^{G}=Φ^{G}=75° (see Eqs. (1A-1B). The angle θᵢ^{G} controls the amount of overlap between the modes.

From Eq. (3b) we get Eq. (5):

$${ΔΘ}^{V} = {sin}^{- 1} ( \frac{- {n}_{2} sin {θ}_{d}^{G} sin {φ}_{d}^{V} + \frac{M λ}{{d}_{inc}} cos {ϕ}_{inc}}{{n}_{1} sin {φ}_{i}^{V}} )$$

To determine the vertical FOV we use φᵢ^{V}=π/2.

Finally, for an in-coupler with ϕ_{inc}=90° we get Eq. (6):

$${φ}_{d}^{V} = \pm {cos}^{- 1} ( \frac{\frac{M λ}{{d}_{inc}}}{{n}_{2} sin {Φ}^{G}} )$$

$${ΔΘ}^{V} = {sin}^{- 1} ( \frac{{n}_{2} sin {Φ}^{G} sin {φ}^{V}}{{n}_{1}} )$$

Let us calculate the pitches of the EPE and out-coupling gratings for one waveguide full color system. To determine the desired grating periods of the EPE and out-coupling gratings, we start with the basic equation for a diffraction grating in conical mounting. The grating equations for the EPE diffraction gratings can be written as Eq. (7):

$${n}_{2} sin {θ}_{e} cos {φ}_{e} + {n}_{2} sin {θ}_{d} cos {φ}_{d} = \frac{N λ}{{d}_{epe}} sin {ϕ}_{epe}$$

$${n}_{2} sin {θ}_{e} sin {φ}_{e} + {n}_{2} sin {θ}_{d} sin {φ}_{d} = \frac{N λ}{{d}_{epe}} cos {ϕ}_{epe} .$$

Here θ_{d} is an incident polar angle diffracted by the in-coupling grating; θₑ is the polar angle diffracted by the EPE grating for diffraction order N of EPE grating; φ_{d} and φₑ are incident (angle diffracted by the in-coupling grating) and diffracted azimuth angles, dₑₚₑ is the period of EPE diffraction grating, the EPE diffraction grating orientation angle is φₑₚₑ.

It is interesting to note that the deviating EPE grating will limit the vertical FOV of the total system. This limitation is connected with the fact that it is desirable for the diffracted angles θₑ to be also kept above the TIR limit.

The out-coupling system is described by such system of diffraction grating equations, Eq. (8):

$${n}_{1} sin {θ}_{o} cos {φ}_{o} + {n}_{2} sin {θ}_{e} cos {φ}_{e} = \frac{L λ}{{d}_{out}} sin {ϕ}_{out}$$

$${n}_{1} sin {θ}_{o} sin {φ}_{o} + {n}_{2} sin {θ}_{e} sin {φ}_{e} = \frac{L λ}{{d}_{out}} cos {ϕ}_{out} ,$$

where θ₀, is the polar angle diffracted by the out-coupling grating for diffraction order L of this grating; φ₀ is diffracted azimuth angle, dₒᵤₜ is the period of output-coupling diffraction grating, ϕₒᵤₜ is the grating orientation angle.

Based on the general analysis of distortion free condition for the grating vectors of the system we get Eq. (9):

$$\frac{M}{{d}_{inc}} ( \begin{matrix}sin {ϕ}_{i n c} \\ cos {ϕ}_{i n c}\end{matrix} ) + \frac{N}{{d}_{epe}} ( \begin{matrix}sin {ϕ}_{epe} \\ cos {ϕ}_{epe}\end{matrix} ) - \frac{L}{{d}_{out}} ( \begin{matrix}sin {ϕ}_{o u t} \\ cos {ϕ}_{o u t}\end{matrix} ) = 0 .$$

In the case that ϕ_{inc}=90°, we get Eq. (10):

$$\frac{M}{{d}_{inc}} ( \begin{matrix}1 \\ 0\end{matrix} ) + \frac{N}{{d}_{epe}} ( \begin{matrix}sin {ϕ}_{epe} \\ cos {ϕ}_{epe}\end{matrix} ) - \frac{L}{{d}_{out}} ( \begin{matrix}sin {ϕ}_{out} \\ cos {ϕ}_{out}\end{matrix} ) = 0 .$$

So, the second line of the Eqs. (10) could be represented as Eq. (11):

$$\frac{N}{{d}_{epe}} cos {ϕ}_{epe} = \frac{L}{{d}_{out}} cos {ϕ}_{out} .$$

By substituting Eq. (11) into the first line of the Eqs. (10) we get Eq. (12): and Eq. (13):

$$\frac{{d}_{out}}{L} = \frac{{d}_{inc}}{M} cos {ϕ}_{out} ( tan {ϕ}_{out} - tan {ϕ}_{epe} ) ,$$

$$\frac{{d}_{out}}{N} = \frac{{d}_{inc}}{M} cos {ϕ}_{epe} ( tan {ϕ}_{out} - tan {ϕ}_{epe} ) .$$

As the result for the out-coupler with ϕₒᵤₜ=0° we get Eq. (14):

$$\frac{{d}_{out}}{L} = - \frac{{d}_{inc}}{M} tan {ϕ}_{epe} ,$$

### and Eq. (15):

$$\frac{{d}_{epe}}{N} = - \frac{{d}_{i n c}}{M} sin {ϕ}_{epe} .$$

For positive in-coupled order we use negative orders diffracted by EPE and out-coupling gratings.

Let us consider the parameters of the in-coupling metagrating proposed to in-couple three colors into the single waveguide system. The next table (Table 1) shows some practical parameters and the calculated values according to the previously solved set of equations for two diffraction gratings at three different wavelengths and n₂ corresponding to sapphire material. Taking into account the dispersion of sapphire (Al₂O₃), for three different colors we have such values of the refractive index:
At λ=460 nm (blue color) n₂=1.7782;
At λ=530 nm (green color) n₂=1.7719;
At λ=638 nm (red color) n₂=1.7657.

In Table 1, the parameters of the example system that were selected are marked by an asterisk. The remaining parameters were calculated as described herein using the selected parameters.

To calculate the pitch at three different wavelengths for the diffraction gratings configured to in-couple first diffraction order (M_{1,2}=1), we use Eqs. (1) and (2).

TABLE 1
(d = 1145.67 nm, M*₁ = 4, M*₂ = 3)

| | λ = 460 nm | λ = 530 nm | λ = 638 nm |
|---|---|---|---|
| DG1 (M₁ = 1) | ${d}_{inc 1} = \frac{d}{4} = 2 86.4 nm$ | | |
| Θ₁^{G} | −6.4°* | 7.99º | 31.47° |
| Φ₁^{G} | 75°* | 75°* | 75°* |
| Θ₁^{C} | 37.3° | 58.27° | >90° |
| DG2 (M₂ = 1) | ${d}_{inc 2} = \frac{d}{3} = 3 81.89 nm$ | | |
| Θ₂^{G} | | −18.89° | −2°* |
| Φ₂^{G} | | 75°* | 75°* |
| Θ₂^{C} | | 32.82° | 42.11º |

The FoV may be limited by the angular range [−θ^{C}₁; θ^{C}₁] for blue color, where θ^{C}₁=37.3°. As we can see, we overlapped some angles near normal incidence in symmetric diffraction direction to avoid missing content due to non-coupled image parts for some colors, and we propose the horizontal FOV ΔΘ^{H} of full RGB system should be equal to 2×37.3=74.6° (this value corresponds to 2×Θ₁^{C} for blue color). We can see that such system achieves high field of view using just one waveguide. But if the index of refraction of the waveguide is increased, an even higher field of view can be achieved for full RGB system with single waveguide.

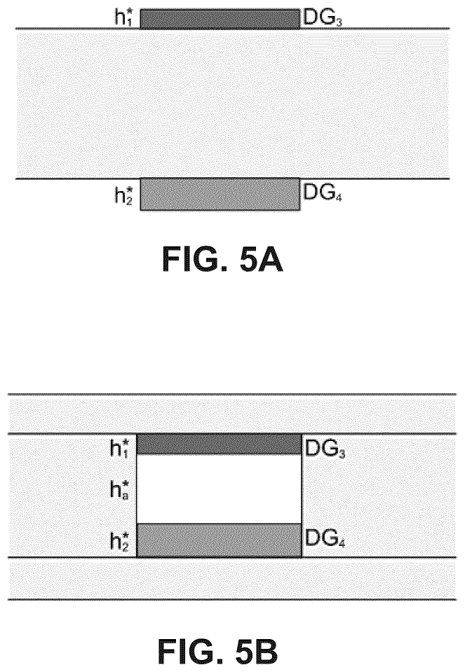

Let us consider an example embodiment that includes two EPE gratings dedicated to different constitutive part of the in-coupling metagrating (DG1 and DG2 of FIG. 2B). Two examples of solutions for the combination of EPE gratings DG3 and DG4 are presented in FIGS. 5A-5B.

FIG. 5A is a schematic cross-sectional side view of a portion of a waveguide showing an external combination of EPE gratings. One example embodiment, as shown in FIG. 5A, corresponds to the combination of the so-called top and bottom external EPE gratings DG3 and DG4 setting from both sides of the waveguide. In an example, DG3 is dedicated to reflection of the portion of light diffracted by the reflective grating DG1, and the grating DG4 is dedicated to reflect the portion of light diffracted by the reflective grating DG2. If reflective grating DG1 with a period d_{inc1} is configured for the blue color and transmissive grating DG2 with a period d_{inc2} is configured for the red color, using Eq. (15) we can calculate the periods dₑₚₑ₁ and dₑₚₑ₂ for the EPE gratings DG3 and DG4 as Eq. (16):

$$\frac{{d}_{epe 1}}{{N}_{1}} = - \frac{{d}_{inc 1}}{{M}_{1}} sin {ϕ}_{epe 1}$$

### and Eq. (17):

$$\frac{{d}_{epe 2}}{{N}_{2}} = - \frac{{d}_{inc 2}}{{M}_{2}} sin {ϕ}_{epe 2} .$$

Here N₁ and N₂ correspond respectively to the diffraction orders of the first and second EPE gratings, ϕ_{epe1,epe2} are orientations of the gratings DG3 and DG4. Selecting numerically the full system parameters we have obtained that for the grating combination with ϕₑₚₑ₁≠ϕₑₚₑ₂ we can get bigger vertical FoV of the total system.

Using Eq. (14) we can obtain the periods of two out-coupling gratings of the system. Eq. (18):

$$\frac{{d}_{out 1}}{{L}_{1}} = - \frac{{d}_{inc 1}}{{M}_{1}} tan {ϕ}_{epe 1}$$

### Eq. (19):

$$\frac{{d}_{out 2}}{{L}_{2}} = - \frac{{d}_{inc 2}}{{M}_{2}} tan {ϕ}_{epe 2}$$

L₁ and L₂ correspond respectively to the diffraction orders of the first and second out-coupling diffraction gratings DG7 and DG8. Combination of the diffraction gratings DG7 and DG8 is presented in FIG. 3 as the third out-coupling metagrating MG3.

FIG. 5B is a schematic cross-sectional side view of a portion of a waveguide showing an internal EPE metagrating MG2. In the embodiment illustrated in FIG. 5B, two EPE gratings DG3 and DG4 are embedded in the waveguide. Such a combination of EPE diffractive gratings can be considered as EPE metagrating solution MG2 shown in FIG. 3. To get the pitches of the constitutive parts of such EPE metagrating we can also use Eqs. (16) and (17) in some embodiments. The distance between the elements of these gratings may be selected to avoid undesirable mutual effect of the grating combination. For the configurations proposed below, this distance may be above one wavelength for the biggest wavelength.

In some embodiments, to construct the EPE metagrating MG2, we combine two plates with first EPE (DG3) and second EPE (DG4) diffraction gratings. The distance between the plates/substrates may be equal to h′₁+h′₂+h′ₐ, where h′ₐ is the distance between the elements, h′₁ and h′₂ are the heights of the gratings (see FIG. 5B). This distance between the elements of two gratings and substrates may be filled by a material with low refractive index n₁ (n₁<n₂). In general, this media can be air, but it can alternatively be a vacuum or another material. To provide the total reflection of the diffracted light only by the external (horizontal) walls of the waveguide we can put the thin layers of the thickness h′₁+h′₂+h′ₐ and with refractive index n₂ between the plates with the diffraction gratings on both sides of the gratings. The plates may be laminated to one another using an adhesive with substantially the same refractive index n₂ to prevent the reflection by the boundaries of these layers.

Let us consider example parameters of the EPE metagrating MG2. Table 2 shows the parameters of the full system including the periods of out-coupling gratings DG7 and DG8. Orientation of the EPE gratings DG3 and DG4 were selected to provide a high vertical FoV of the full system.

TABLE 2
Parameters of the full color system of metagratings

| | Red color | Blue color |
|---|---|---|
| λ | 638 nm | 460 nm |
| d_{inc} | d_{inc1} = 382 nm | d_{inc2} = 286 nm |
| ϕ_{inc} | ϕ_{inc1} = 90° | ϕ_{inc2} = 90° |
| dₑₚₑ | dₑₚₑ₁ = 287 nm | dₑₚₑ₂ = 226 nm |
| ϕₑₚₑ | ϕₑₚₑ₁ = 48.7° | ϕₑₚₑ₂ = 52° |
| dₒᵤₜ | dₒᵤₜ₁ = 435 nm | dₒᵤₜ₂ = 367 nm |
| ϕₒᵤₜ | ϕₒᵤₜ₁ = 0° | ϕₒᵤₜ₂ = 0° |

The resulting parameters of Table 2 are illustrated graphically in FIG. 3E.

Analyzing the parameters of this full system we already demonstrated that for such system horizontal FoV ΔΘ^{H}=74.6°. Using Eq. (5) we get that for blue and red color vertical FOV ΔΘ^{V}=40°. Taking into account that at green color wavelength full angular range will be split between the gratings DG1 and DG2, the out-coupled angular bandpasses for the green color may be confirmed. In this example, due to the EPE gratings' limitation of vertical FOV at green color wavelength, the full vertical FoV of the system will be around ΔΘ^{V}=24°.

We have seen before that the vertical field of view of full color system is limited by the EPE gratings at green color wavelength. For an example EPE metagrating solution we get that the total vertical FoV for all three colors will be almost two times less compare to the possible vertical FoV for blue and red color solutions. At the green color wavelength, combining the light diffracted by two gratings DG3 and DG4 we are not able totally cover full angular range which was in-coupled by DG1 and DG2.

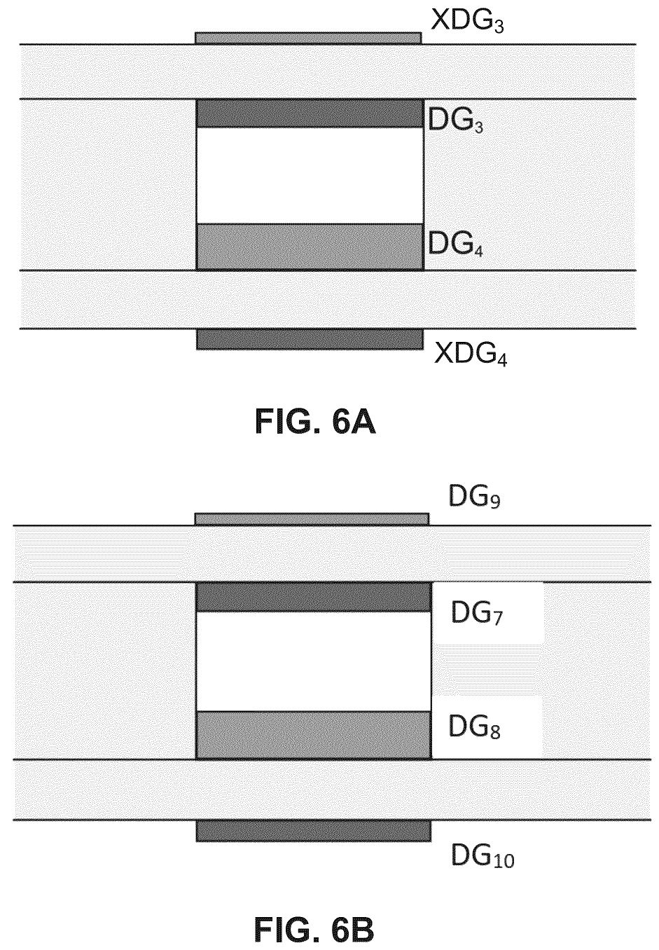

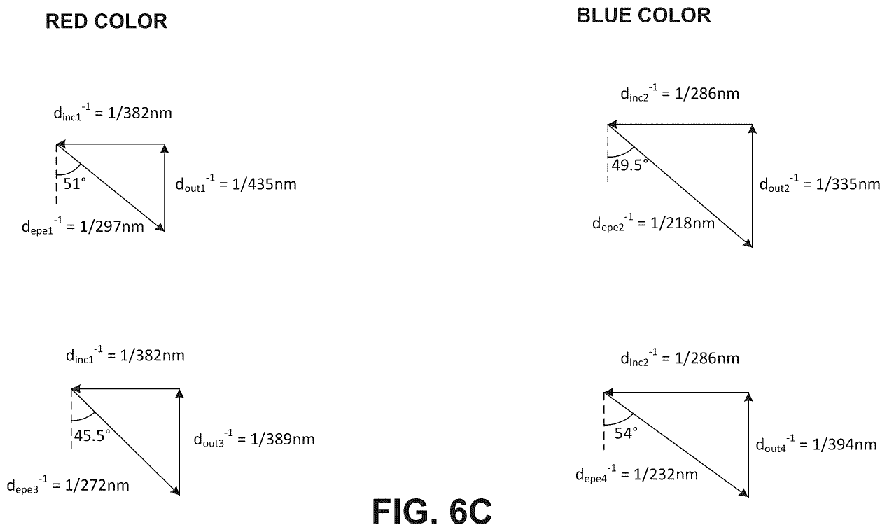

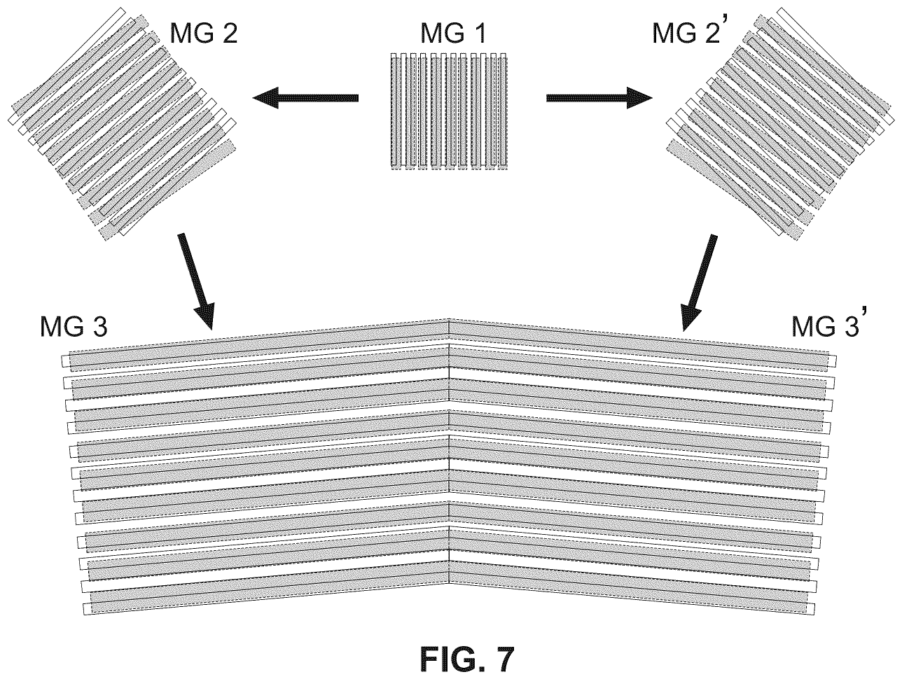

In some embodiments, to increase the vertical FOV of the full color device we propose to use two additional EPE gratings in TIR conical mounting, that act as beam deviators and expanders for the missing portion of the field of view at a green color wavelength. The two additional gratings may be set at different locations. An embodiment with the additional gratings with the EPE metagrating inside the waveguide is presented in FIGS. 6A-6B. In some embodiments, grating XDG3 is on one face of the waveguide grating XDG4 on the opposite face. For proper functioning of the EPE system, it is desirable for the portion of light in-coupled by the DG1 to be finally diffracted primarily or exclusively by the EPE gratings DG3 and XDG3. Correspondingly it is desirable for the portion of light in-coupled by DG2 to be diffracted primarily or exclusively by the EPE gratings DG4 and XDG4. Each pair of the EPE gratings is configured for use with the proper azimuth angles. For that purpose, some embodiments use a physical way to separate both optical paths. Regarding this issue, we analyze below the reflectivity of high refractive index reflective gratings along full azimuth angular range. We demonstrate that the proper position/order of the gratings can separate optical paths.

In some embodiments, the gratings are configured such that the two gratings in a pair act on different polarizations. For instance, the EPE metagrating MG2 inside the waveguide primarily diffracts TE polarized light while if it is hit by TM polarized light, the later reflects back by TIR inside of the waveguide. The external EPE gratings will diffract primarily TM polarized light and TIR-reflect the TE polarized one. In this case the light engine is configured to emit both polarizations, and the in-coupling system is configured to diffract both polarizations. In some embodiments, a metagrating includes different gratings that diffract different polarizations.

FIG. 6A is a schematic cross-sectional side view of a portion of a waveguide showing an arrangement of four EPE gratings.

FIG. 6B is a schematic cross-sectional side view of a portion of a waveguide showing an arrangement of four out-coupling gratings.

Consider the parameters of the solution for the case of four EPE diffraction gratings' system. Table 3 shows the parameters of the full system including the periods of four out-coupling gratings. In an example, two additional out-coupling gratings (DG9 and DG10) are dedicated to out-coupling of the light diffracted by the XDG3 and XDG4. The system of four out-coupling gratings may have a similar side view as the system of EPE gratings, where DG7 and DG8 will be the parts of out-coupling metagratings MG3 embedded into the waveguide and two additional out-coupling gratings DG9 and DG10 may be the external EPE gratings. Taking into account the different functionality, to out-couple the light the full system of out-coupling gratings may include two reflective (gratings DG7 and DG10, for example) and two transmissive gratings (gratings DG8 and DG9, for example). For the presented case, all out-coupling gratings have the same orientation and ϕₒᵤₜ=0°. Considering the possible horizontal and vertical FoVs for this system, we can see that for the chosen orientation of all EPE gratings we are able to keep maximal vertical FoV ΔΘ^{V}=40°.

TABLE 3
Parameters of the full color system of metagratings, high FoV

| | Red color | Blue color |
|---|---|---|
| λ | 638 nm | 460 nm |
| d_{inc} | d_{inc1} = 382 nm | d_{inc2} = 286 nm |
| ϕ_{inc} | ϕ_{inc1} = 90° | ϕ_{inc2} = 90° |
| dₑₚₑ | dₑₚₑ₁ = 297 nm | dₑₚₑ₂ = 218 nm |
| ϕₑₚₑ | ϕₑₚₑ₁ = 51° | ϕₑₚₑ₂ = 49.5° |
| dₒᵤₜ | dₒᵤₜ₁ = 472 nm | dₒᵤₜ₂ = 335 nm |
| ϕₒᵤₜ | ϕₒᵤₜ₁ = 0° | ϕₒᵤₜ₂ = 0° |
| d_{epe additionnal} | dₑₚₑ₃ = 272 nm | dₑₚₑ₄ = 232 nm |
| ϕ_{epe additionnal} | ϕₑₚₑ₃ = 45.5° | ϕₑₚₑ₄ = 54° |
| d_{out additionnal} | dₒᵤₜ₃ = 389 nm | dₒᵤₜ₄ = 394 nm |
| ϕ_{out additionnal} | ϕₒᵤₜ₃ = 0° | ϕₒᵤₜ₄ = 0° |

The parameters of Table 3 are illustrated graphically in FIG. 6C. Diffraction gratings in an example embodiment may be arranged with grating vectors oriented as shown in FIG. 6C.

As it was mentioned above, the possible combination of four out-coupling gratings could coincide with the combination of the EPE gratings presented in FIG. 6A. Due to the mutual effect, such combination of reflective and transmissive gratings in the case of out-coupling system may not provide very high efficiency of out-coupling light. For example, the portion of light reflected by the external reflective gratings DG10 is totally transmitted through the rest of the gratings (DG7+DG8+DG9). These gratings will affect the response of DG10 and reduce the efficiency of reflected light. In the case of transmissive gratings DG8, consideration is taken of the effect of the gratings DG7 and DG9. The efficiency of the red color may be less than the out-coupled efficiency of the blue one. The light engine or other image generator may be configured compensate for this.

With proper selection of the orientation of the gratings in EPE system as described herein, we can reduce the number of out-coupling gratings up to two gratings. So, as in the case of in-coupling system, for the out-coupling solution, some embodiments combine one transmissive and one reflective surface relief grating placed on both sides of the waveguide. Some embodiments use a metagrating solution with the combination of reflective and transmissive gratings inside the waveguide or two transmissive gratings on the top of the waveguide, for example. The parameters of the example solution for the case of four EPE diffraction gratings' system with just two out-coupling gratings are presented in Table 4. Side view of the out-coupling system could coincide with the two cases (external gratings and internal metagrating MG3) presented in FIG. 5 for EPE elements. DG7 will out-couple the light diffracted by DG3 and XDG4, and DG8 will out-couple the light diffracted by DG4 and XDG3. For the analysis of FoV for the full system, the grazing limit is considered to be 80°. We can see that in this case for the chosen orientation of all EPE gratings we are able to keep maximal vertical FOV ΔΘ^{V}=50°. Let us note that for this configuration to increase the vertical FoV, the additional EPE gratings also partially cover azimuth angular ranges for the blue and red colors.

TABLE 4
Parameters of the full color system of metagratings, high FoV

| | Red color | Blue color |
|---|---|---|
| λ | 638 nm | 460 nm |
| d_{inc} | d_{inc1} = 382 nm | d_{inc2} = 286 nm |
| ϕ_{inc} | ϕ_{inc1} = 90° | ϕ_{inc2} = 90° |
| dₑₚₑ | dₑₚₑ₁ = 245 nm | dₑₚₑ₂ = 240 nm |
| ϕₑₚₑ | ϕₑₚₑ₁ = 40° | ϕₑₚₑ₂ = 61.5° |
| d_{epe additionnal} | dₑₚₑ₃ = 304 nm | dₑₚₑ₄ = 208 nm |
| ϕ_{epe additionnal} | ϕₑₚₑ₃ = 52.8° | ϕₑₚₑ₄ = 49.5° |
| dₒᵤₜ | dₒᵤₜ₁ = 320 nm | dₒᵤₜ₂ = 503 nm |
| ϕₒᵤₜ | ϕₒᵤₜ₁ = 0° | ϕₒᵤₜ₂ = 0° |

Example embodiments include a waveguide apparatus with a two-grating in-coupler (DG1, DG2), a four-grating EPE (DG3, DG4, XDG3, XDG4), and a two-grating out-coupler (DG7, DG8).

In some embodiments, two set of similar out-coupling metagratings (MG3 and MG3′) are symmetrically oriented at some angles to the x-axis (see FIG. 7) and combined together. In some embodiments, in each metagrating, the out-coupling gratings could be also differently oriented.

FIG. 7 is a schematic front view of an example layout of diffraction gratings for a full color waveguide having metagrating in-coupler (MG1), EPE system (MG2 and MG2′) and out-coupling grating system (MG3 and MG3′).

To demonstrate the possible separation of the optical paths for the rays diffracted by the EPE gratings and to determine the position of the EPE gratings, we describe and the reflectivity of high refractive index reflective gratings along azimuth angular range.

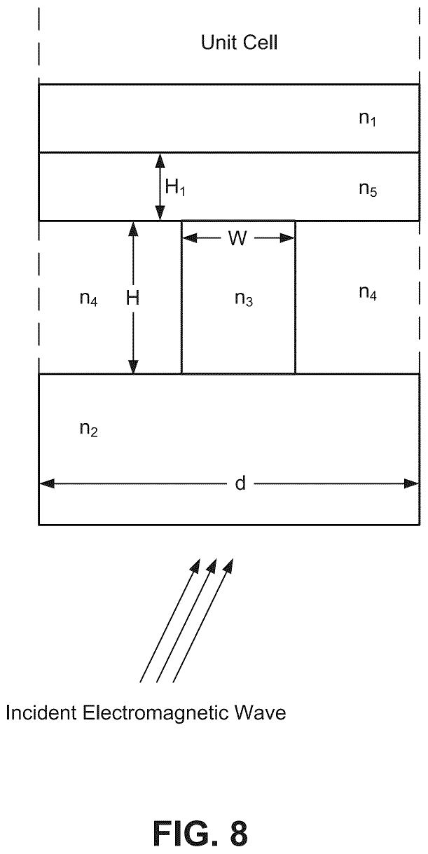

To analyse the response along full azimuth angle range we considered the high refractive index material reflective diffraction grating placed on the waveguide surface. The general topology of the unit cell of symmetrical reflective diffraction grating is illustrated in FIG. 8. This cross-section view may correspond to high refractive index (n₃) element on the bottom of a homogeneous dielectric media with a refractive index n₂ (n₃>n₂). In some embodiments all EPE gratings have the same structure and materials. But in general case the structure and high index material for the gratings can be different. The high refractive index element is covered by the material with lower refractive index n₄ (n₃>n₄). The full system is hosted by the homogeneous host medium with refractive index n₁. In some embodiments n₁<n₂ and n₁<n₄. W and H are width and height of the high refractive index element (in general case the parameters of the high index elements for DG1-DG4 are different). H₁ is the thickness of the layer with refractive index n₅. To create the diffraction grating, we take a periodic array of the unit cells. In some embodiments, all gratings act on the same polarization. A linearly polarized TE plane wave is incident on the grating from the waveguide material from the bottom in FIG. 8.

Examples of configurations for EPE gratings according to some embodiments are as follows.

Some embodiments use silicon (Si) as the material of the elements of the grating (n₃=3.897+i0.021061 for the red color wavelength). In some embodiments, the elements are covered by SiO₂ material (n₄=n₅=1.457 for the red color wavelength). A linearly polarized TE plane wave is incident on the grating form the waveguide material from the bottom in FIG. 8.

In some embodiments, AlAs is the material of the element of the gratings. Below we will provide the simulations for AlAs gratings with:
At λ=460 nm (blue color) n₃=3.4739+i0.014;
at λ=530 nm (green color) n₃=3.2735+i0.0042;
at λ=638 nm (red color) n₃=3.121+i0.00092.

In some embodiments, elements are not additionally covered by another material (n₄=n₅=1).

FIG. 8 is a schematic cross-sectional views of a unit cell of high refractive index material reflective diffraction grating.

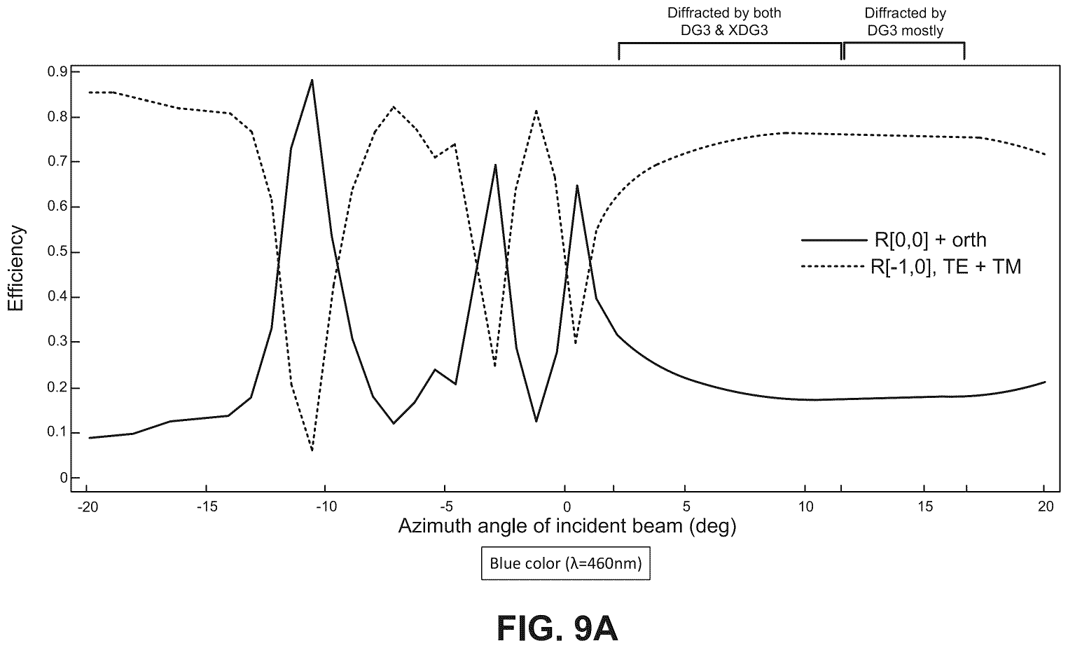

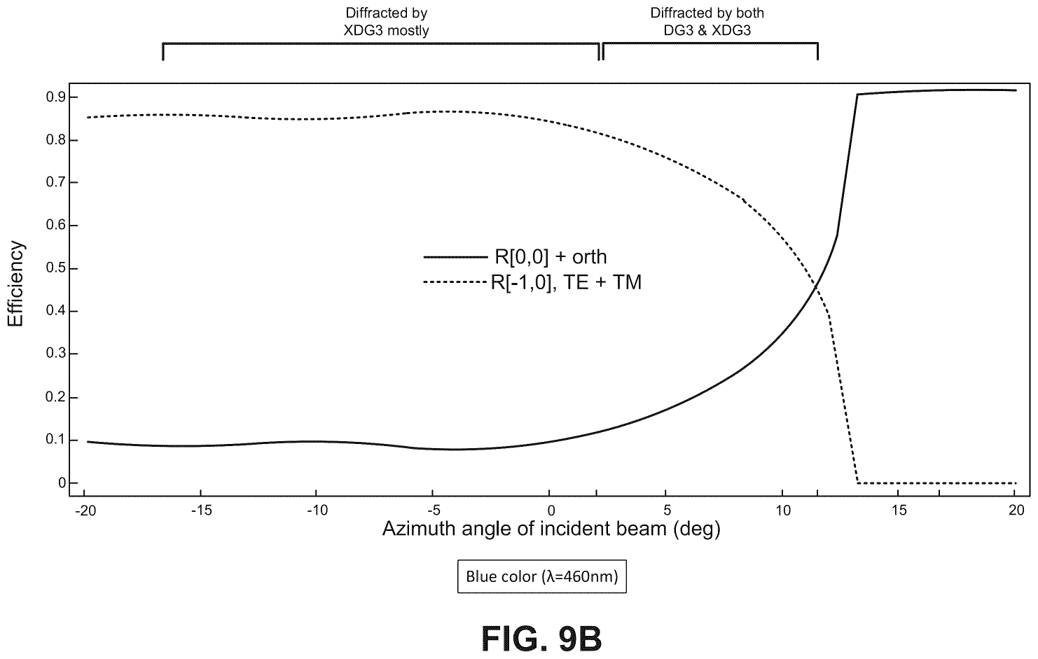

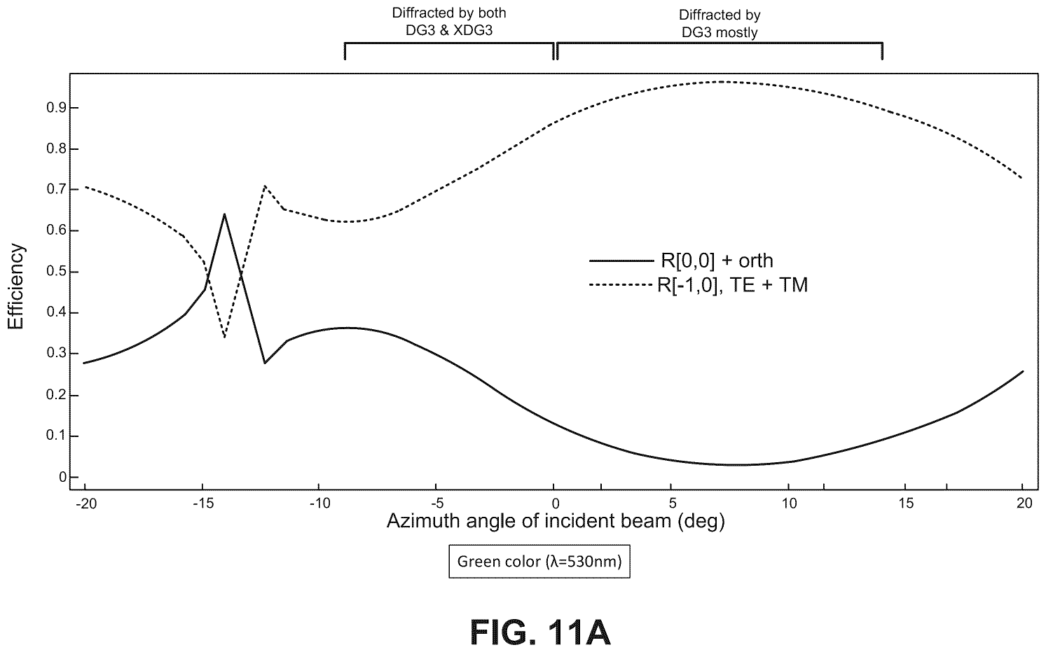

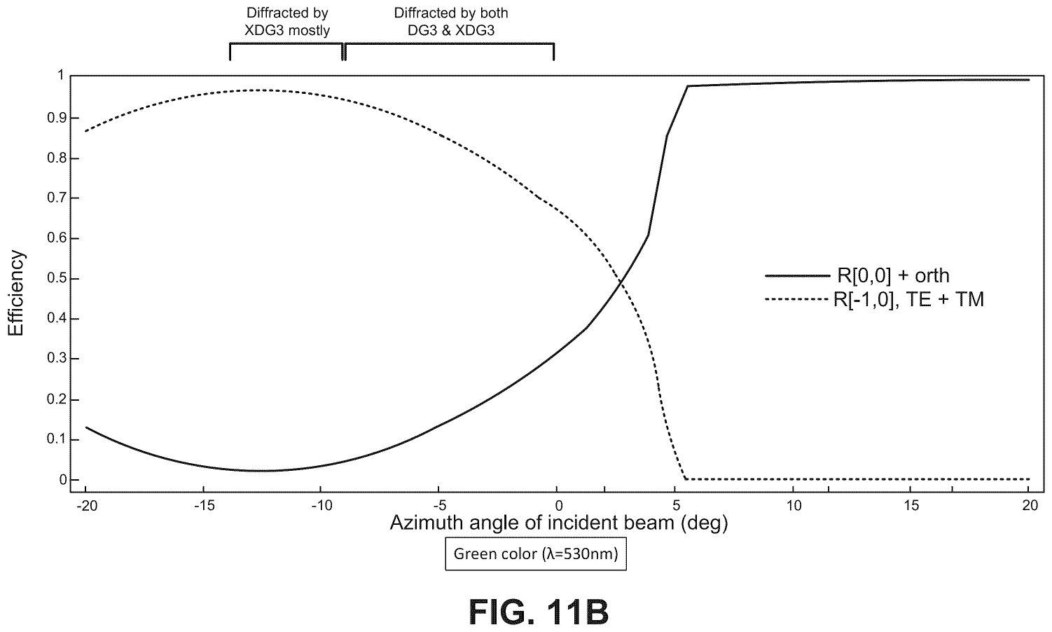

For the configuration of an example grating, according to some embodiments, it is desirable for this EPE grating to diffract substantially all incident light (has maximally possible reflectance for the first order R₋₁). Assuming that the incident polar angle is equal to θ_{d}=50°, we can calculate that at the blue color wavelength first EPE grating DG3 covers an angular range 2°<φ_{d}<16.7° and an additional grating XDG3 covers the range −16.7°<φ_{d}<11.5° (see FIG. 9A for DG3 and FIG. 9B for XDG3). Combining the response providing by these two gratings we can cover the full range for the in-coupled azimuth angles −16.7°<φ_{d}<16.7° at blue color wavelength (this angular range inside the waveguide material will correspond to the total vertical FoV equal to 50° outside the waveguide) with overlapping corresponding to 2°<φ_{d}<11.5°. Analyzing the response of these two gratings we get that the in-coupled light may be expected to hit XDG3 before hitting DG3. We get that for the grating XDG3 the reflectance of the deviated order [−1,0] will be about 85% for wide angular range before overlapping area. For the same angular range, we get that the reflectance of non-deviated order [0,0] will be about 10%. For the overlapping angular range, we observe an increase of the reflectance of non-deviated order [0,0] and decrease of the reflectance for the deviated order [−1,0]. It means that for the overlapping area a portion of the light deviated by the XDG3 will be combined with a portion of light which was initially reflected by XDG3 (order R[0,0]) and diffracted after by the grating DG3 (order R[−1,0]). For 11.5°<φ_{d}<16.7° incident light will be totally deviated by the second grating DG3 with R[−1,0] about 75%. We can see that at the green color wavelength first EPE grating DG3 covers an angular range −9°<φ_{d}<14° and an additional grating XDG3 covers the range −14°<φ_{d}<0° (see FIG. 11A for DG3 and FIG. 11B for XDG3). Combining the response providing by these two gratings we get the full range for the in-coupled azimuth angles −14°<φ_{d}<14° with the overlapping area corresponding to −9°<φ_{d}<0° at the green color wavelength (this angular range inside the waveguide material will also correspond to the total vertical FoV equal to 50° outside the waveguide). Putting XDG3 before DG3 we get that for the grating XDG3 the reflectance of the deviated order [−1,0] will be above 90% for the angular range before overlapping area. For this angular range, we get that the reflectance of non-deviated order [0,0] will be very low (<5%). As in the previous case for the overlapping angular range, we observe an increase of the reflectance of non-deviated order [0,0] and decrease of the reflectance for the deviated order [−1,0]. So, for the overlapping area a portion of the light deviated by the XDG3 will be combined with a portion of light which was initially reflected by XDG3 (order R[0,0]) and diffracted after by the grating DG3 (order R[−1,0]). For the angular range 0°<φ_{d}<14° incident light will be deviated by the second grating DG3 with R[−1,0]>85%.

FIGS. 9-14 illustrate diffraction performance of AlAs gratings using the unit cell as depicted in FIG. 8).

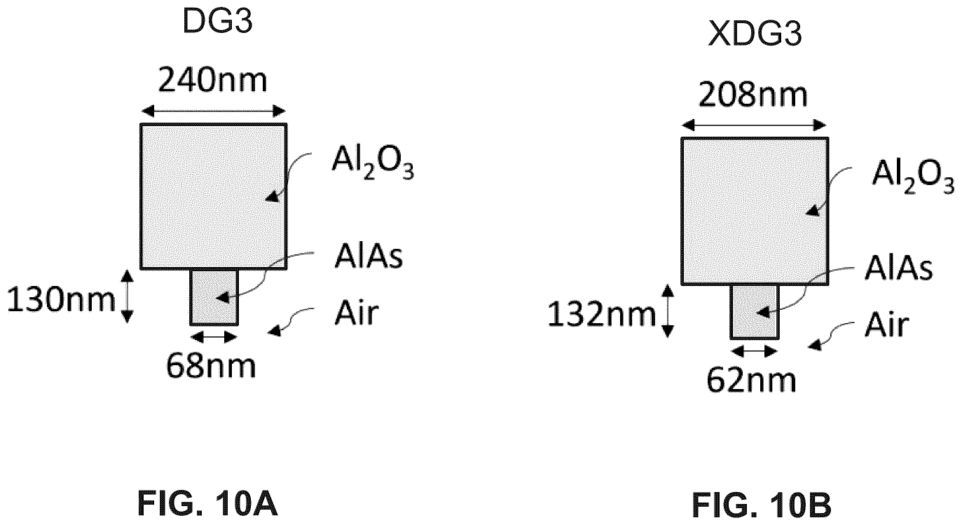

FIG. 9A illustrates diffraction performance of DG3 at a blue color wavelength using a unit cell configuration as shown in FIG. 10A.

FIG. 9B illustrates diffraction performance of XDG3 at a blue color wavelength using a unit cell configuration as shown in FIG. 10B.

FIG. 10A illustrates an example unit cell configuration for DG3.

FIG. 10B illustrates an example unit cell configuration for XDG3.

FIG. 11A illustrates diffraction performance of DG3 at a green color wavelength using a unit cell configuration as shown in FIG. 10A.

FIG. 11B illustrates diffraction performance of XDG3 at a green color wavelength using a unit cell configuration as shown in FIG. 10B.

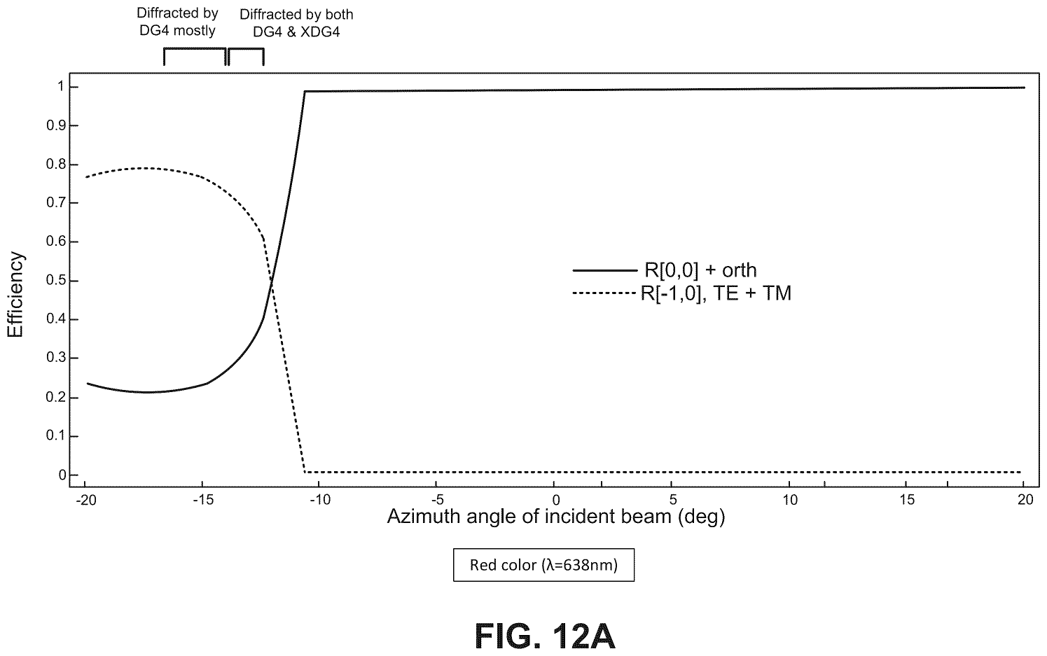

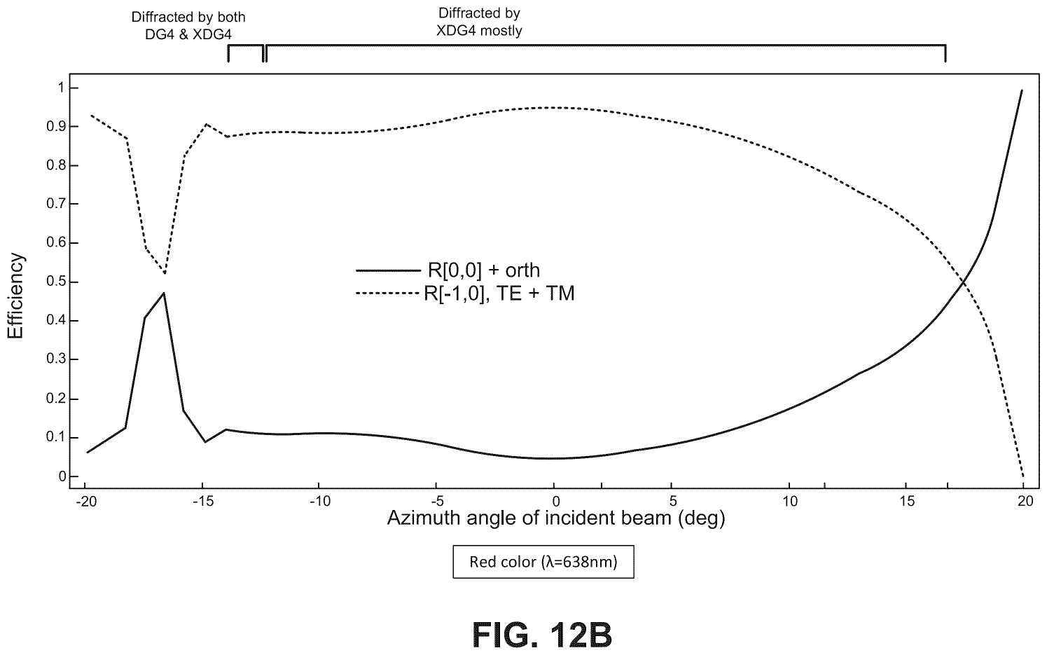

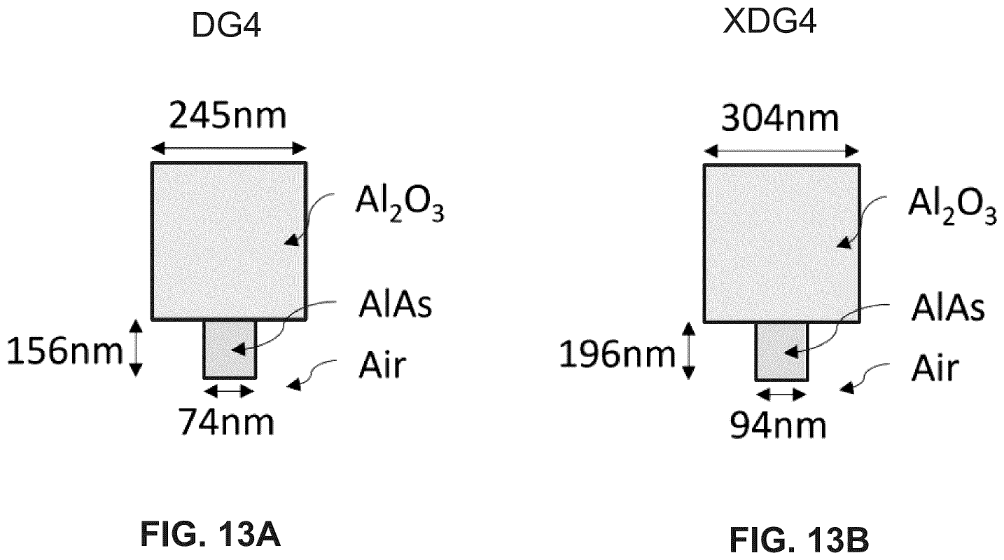

FIG. 12A illustrates diffraction performance of DG4 at a red color wavelength using a unit cell configuration as shown in FIG. 13A.

FIG. 12B illustrates diffraction performance of XDG4 at a red color wavelength using a unit cell configuration as shown in FIG. 13B.

FIG. 13A illustrates an example unit cell configuration for DG4.

FIG. 13B illustrates an example unit cell configuration for XDG4.

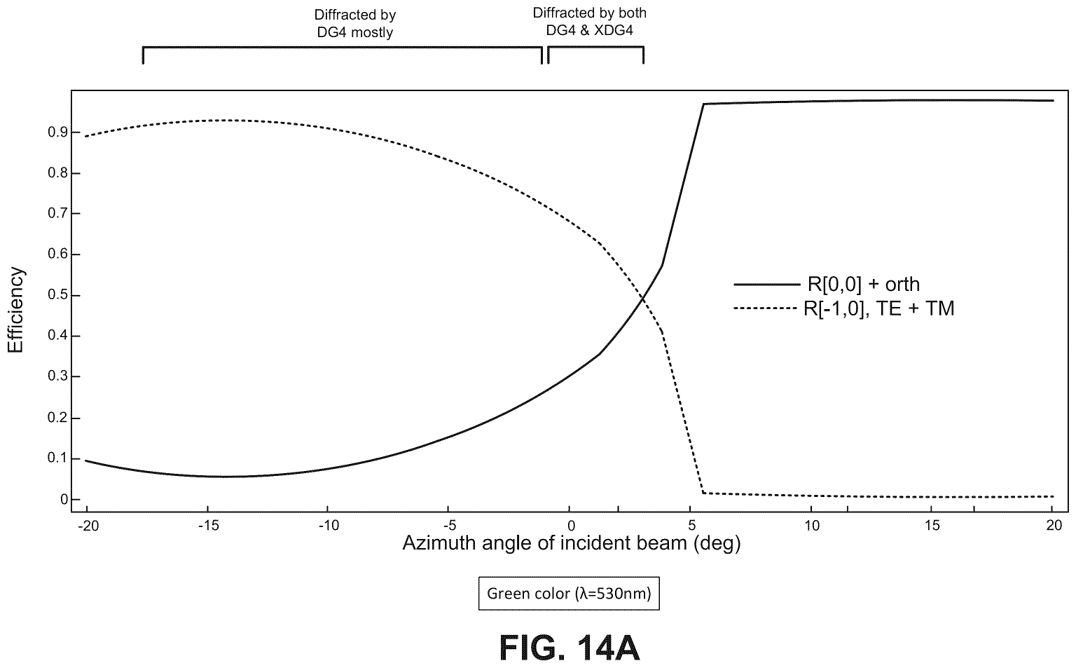

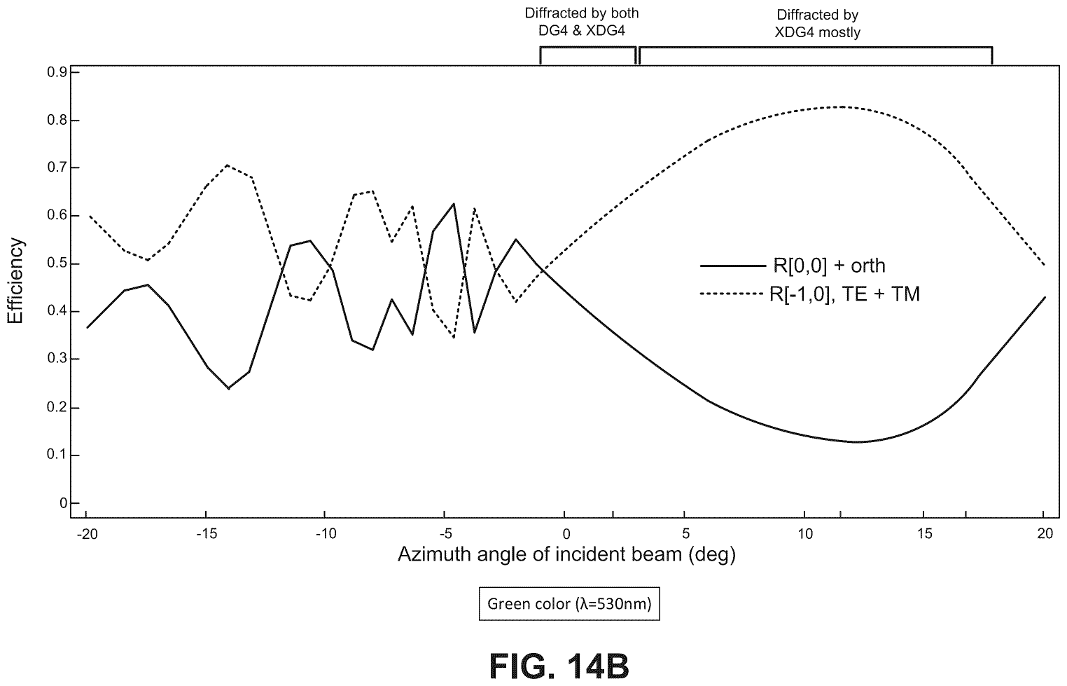

FIG. 14A illustrates diffraction performance of DG4 at a green color wavelength using a unit cell configuration as shown in FIG. 13A.

FIG. 14B illustrates diffraction performance of XDG4 at a green color wavelength using a unit cell configuration as shown in FIG. 13B.

The graphs illustrate areas of angular overlapping for two EPE gratings; top and bottom gratings could diffract for these angles. The graphs also illustrate an angular range diffracted only or primarily by the corresponding grating.

The configuration for the gratings DG4 and XDG4 at incident polar angle equal to θ_{d}=50° is presented in FIGS. 12-14. At the red color wavelength EPE grating DG4 covers an angular range −16.8°<φ_{d}<−12.5° and an additional grating XDG4 covers the range −14°<φ_{d}<16.8° (see FIG. 12A for DG4 and FIG. 12B for XDG4). Combining these two gratings we can cover the range −16.8°<φ_{d}<16.8° at red color wavelength (this angular range inside the waveguide material will correspond to the total vertical FoV equal to 50° outside the waveguide) with overlapping corresponding to −14°<φ_{d}<−12.5°. Analyzing the response of these two gratings, we conclude that the in-coupled light may be expected to hit the grating DG4 before hitting the gratings XDG4. We get that for the grating DG4 the reflectance of the deviated order [−1,0] will be >75% for the angular range before overlapping area. For the same angles, we observe that the reflectance of non-deviated order [0,0] will be equal to 20-25%. For the overlapping area a portion of the light deviated by the DG4 will be combined with a portion of light which was initially reflected by DG4 (order R[0,0]) and diffracted after by the grating XDG4 (order R[−1,0]). For the angles −12.5°<φ_{d}<16.8° incident light will be totally deviated by the second grating XDG4 with maximal R[−1,0] about 95% and minimal R[−1,0] about 55%. At the green color wavelength, DG4 covers an angular range −18°<φ_{d}<3° and XDG4 covers the range −1°<φ_{d}<18° (see FIG. 14A for DG4 and FIG. 14B for XDG4). Combining these two gratings we can totally cover the vertical FoV corresponding to in-coupled azimuth angles −18°<φ_{d}<18° with overlapping area corresponding to −1°<φ_{d}<3° at the green color wavelength (this angular range inside the waveguide material will also correspond to the total vertical FoV equal to 50° outside the waveguide). For the grating DG4 the reflectance of the deviated order [−1,0] will be changed between 90% and 70% for the angular range before overlapping area. For the overlapping area a portion of the light deviated by the DG4 will be combined with a portion of light which was initially reflected by DG4 (order R[0,0]) and diffracted after by the grating XDG4 (order R[−1,0]). For the angular range 3°<φ_{d}<18° incident light will be deviated by the grating XDG4 with R[−1,0] between 65% and 82%.

Example embodiments described herein provide a full-color single-waveguide EPE system. In some embodiments, the vertical FoV is increased as compared to prior full single-waveguide RGB systems.

In some embodiments, a configuration of a dual-diffraction-grating EPE system is provided for a full color single-waveguide solution. In some such embodiments, a combination of two reflective diffraction gratings is placed on both sides of the waveguide. In some embodiments, a combination of two reflective diffraction gratings is embedded into the waveguide (metagrating EPE). In some embodiments, to increase the vertical FoV, different orientations of the grating lines of the two EPE gratings are used.

In some embodiments, a configuration of a diffraction grating EPE system is provided including four EPE gratings for a full color system with high vertical FoV. In some embodiments, both gratings are configured to use unpolarized light. In other embodiments, different gratings are configured to use different polarizations.

The out-coupling system may take into account the full number of the EPE gratings in the system.

In some embodiments, a waveguide display apparatus includes two in-coupling gratings, two eye pupil expander gratings, and two out-coupling gratings.

In some embodiments, a waveguide display apparatus includes two in-coupling gratings, four eye pupil expander gratings, and four out-coupling gratings.

In some embodiments, a waveguide display apparatus includes two in-coupling gratings, four eye pupil expander gratings, and two out-coupling gratings.

Example embodiments may be implemented using standard microfabrication techniques.

While the grating structures are primarily described herein for use as diffractive in-couplers for waveguide displays, such structures may also be used as diffractive out-couplers or in other diffraction grating applications, or in applications combining diffractive elements. Applications of the grating structures described herein are not limited to visible light applications. With appropriate changes to the dimensions of grating elements and their spacing, embodiments may be used for electromagnetic wavelengths longer or shorter than those of visible light. In those cases, descriptions that refer to transparency, opacity, reflectivity, refractive indices, and the like should be understood with respect to the relevant wavelengths.

In the present disclosure, modifiers such as “first,” “second,” “third,” and the like are sometimes used to distinguish different features. These modifiers are not meant to imply any particular order of operation or arrangement of components. Moreover, the terms “first,” “second,” “third,” and the like may have different meanings in different embodiments. For example, a component that is the “first” component in one embodiment may be the “second” component in a different embodiment. Similarly, modifiers such as “top” and “bottom” or “upper” and “lower” are used only to distinguish relative positions of different features; it should be understood that, depending on how an apparatus is oriented, a portion described as the “top” or “upper” portion may temporarily or permanently be in a lower position, a leftward position, a rightward position, and so on, without departing from the principles described herein.

Although features and elements are described above in particular combinations, one of ordinary skill in the art will appreciate that each feature or element can be used alone or in any combination with the other features and elements.

1. An apparatus comprising:
a waveguide having an in-coupler, an out-coupler, and at least a first eye-pupil expander along a first optical path from the in-coupler to the out-coupler, wherein:
the in-coupler comprises a first diffraction grating (DG1) and a second diffraction grating (DG2) overlaying the first diffraction grating, wherein grating lines of the first and second diffraction gratings are parallel to one another;
the first eye-pupil expander comprises a third diffraction grating (DG3) and a fourth diffraction grating (DG4) overlaying the third diffraction grating; and
the out-coupler comprises a fifth diffraction grating (DG7) and a sixth diffraction grating (DG8) overlaying the fifth diffraction grating.

2. The apparatus of claim 1, wherein the first, third and fifth diffraction gratings provide a first optical path for display of a first portion of a vertical field of view and the second, fourth, and sixth diffraction gratings provide a second optical path for a second portion of the vertical field of view.

3. The apparatus of claim 1, wherein the eye-pupil expander further comprises a seventh diffraction grating and an eighth diffraction grating, the seventh and eighth diffraction gratings overlaying the third and fourth diffraction gratings.

4. The apparatus of claim 1, wherein the out-coupler further comprises a ninth diffraction grating and a tenth diffraction grating, the ninth and tenth diffraction gratings overlaying the fifth and sixth diffraction gratings.

5. The apparatus of claim 1, wherein at least one of the following pairs of diffraction gratings are on opposite surfaces of the waveguide: the first and second diffraction gratings, the third and fourth diffraction gratings, and the fifth and sixth diffraction gratings.

6. The apparatus of claim 1, wherein at least one of the following pairs of diffraction gratings forms a metagrating within the waveguide: the first and second diffraction gratings, the third and fourth diffraction gratings, and the fifth and sixth diffraction gratings.

7. The apparatus of claim 1, wherein grating lines of the third and fourth diffraction gratings are not parallel to one another.

8. The apparatus of claim 1, wherein grating lines of the fifth and sixth diffraction gratings are parallel to one another.

9. The apparatus of claim 1, wherein the first and third diffraction gratings are configured to diffract light having a first polarization state and the second and fourth diffraction gratings are configured to diffract light having a second polarization state orthogonal to the first polarization state.

10. The apparatus of claim 1, further comprising a second eye-pupil expander along a second optical path from the in-coupler to the out-coupler, the second eye-pupil expander being arranged symmetrically with respect to the first eye-pupil expander.

11. A full-color waveguide display device comprising a waveguide apparatus of claim 1.

12. The display device of claim 11, wherein the display device includes an image generator and the in-coupler is configured to couple an image generated by the image generator.

13. A method of operating an apparatus of claim 1, comprising:
generating an image;
in-coupling the image with the in-coupler; and
out-coupling the image with the out-coupler.

14. An apparatus comprising
an image generator configured to generate an image with red, green, and blue light;
a waveguide having a first in-coupler grating (DG1) and a second in-coupler grating (DG2) configured to in-couple the image and at least one out-coupler configured to out-couple the image, the waveguide having:
a first optical path defined by the first in-coupler grating (DG1) and a first pupil expander grating (DG3), the first optical path being configured to convey red light from a left portion of the image and green light from a bottom-left portion of the image to the out-coupler;
a second optical path defined by the first in-coupler grating (DG1) and a second pupil expander grating (DG5), the second optical path being configured to convey red light from a right portion of the image and green light from a bottom-right portion of the image to the out-coupler;
a third optical path defined by a second in-coupler grating (DG2) and a third pupil expander grating (DG4), the third optical path being configured to convey blue light from a left portion of the image and green light from a top-left portion of the image to the out-coupler; and
a fourth optical path defined by the second in-coupler grating (DG2) and a fourth pupil expander grating (DG6), the fourth optical path being configured to convey blue light from a right portion of the image and green light from a top-right portion of the image to the out-coupler.

15. The apparatus of claim 14, wherein:
the first optical path is configured to convey light diffracted by the first in-coupler grating (DG1) to a positive diffractive order;
the second optical path is configured to convey light diffracted by the first in-coupler grating (DG2) to a negative diffractive order;
the third optical path is configured to convey light diffracted by the second in-coupler grating (DG2) to a positive diffractive order; and
the fourth optical path is configured to convey light diffracted by the second in-coupler grating (DG2) to a negative diffractive order.
